(19) United States
(12) Patent Application Publication
(10) Pub. No.: US 2006/0282638 A1
(43) Pub. Date: Dec. 14, 2006

(54) Storage device, configuration information management method and program

(75) Inventors: Shoji Oshima, Kawasaki (JP); Tatsuhiko Machida, Kawasaki (JP); Hirokazu Matsubayashi, Kawasaki (JP); Satoshi Yazawa, Kawasaki (JP); Koichi Tsukada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/223,005

(22) Filed: Sep. 12, 2005

(30) Foreign Application Priority Data
Jun. 10, 2005 (JP) 2005-170743

(51) Int. Cl. G06F 12/00; G06F 12/16

(52) U.S. Cl. 711/170; 711/114

(57) ABSTRACT

A storage system is comprised of a first processing unit (main CPU) comprising a first input/output control unit and a configuration management unit as execution targets, a second processing unit (sub CPU) comprising a second input/output control unit and a higher-priority control unit which has an execution priority higher than the second input/output control unit as execution targets, and a shared memory which is allocated with a configuration table storing configuration information. When receiving a configuration information change instruction, a configuration information change control unit changes the configuration information of the configuration table during the reference of the second input/output control unit to the configuration table is inhibited by forcing the second processing unit to execute processing of the higher-priority control unit and forces the second processing unit to terminate the processing of the higher-priority control unit with completion of the change of the configuration information. The higher-priority control unit is a system control unit, a command relay control unit (maintenance agent) or an exclusive dedicated task control unit.

### CROSS-REFERENCE TO RELATED APPLICATION

This application claims the benefit of priority to prior application No. JP2005-170743, filed Jun. 10, 2005, in Japan, of which full contents are incorporated herein by reference.

### BACKGROUND OF THE INVENTION

1. Field of the Invention

The present invention relates to a storage device, configuration information management method and program comprising volumes with RAID configuration for processing input/output requests from a higher-level device and, more particularly, to a storage device, configuration information management method and program for managing configuration information of a shared memory by CPUs with dual-configuration.

2. Description of the Related Art

Conventionally, a RAID apparatus used as a storage apparatus, such as a global server and an open server, consists of a control module, a channel adapter, a device adapter and a router. The control module is equipped with a CPU, cache and the like and controls the overall operations of the storage apparatus. The channel adapter is a module for connecting the RAID apparatus with various servers and uses interfaces such as a fiber channel, iSCSI and the like. The device adapter is a module for connecting the control module with a drive enclosure equipped with a plurality of magnetic disk drives and uses a fiber channel interface. The router is a module for connecting the channel adapter and the device adapter at a high speed. In such a conventional storage apparatus, the control module is equipped with one (1) CPU, and by executing programs with the CPU, firmware functions can be achieved for system control managing the status of the entire system, input/output control processing input/output requests from servers to user volumes via cache control, maintenance control operated by instructions from a service processor and the like. Among these controls, the system control includes configuration control which deploys a configuration table on a memory at the time of the system start-up, and with user operation, the configuration table stores apparatus setup information such as component configurations and RAID configurations as well as state information such as a status of each component which indicates a current state of the apparatus. If the setup or installation condition of the apparatus is changed during system operation, configuration change processing is performed for changing the configuration information of the configuration table. Also, an input/output control unit executing input/output processing from server refers to the configuration table a needed when the input/output processing is executed. By the way, recently, since operating frequencies of CPUs are approaching to the limit and significant improvement cannot be expected in processing performance, dual-configuration processors has been used and it is also conceivable for the control module of the storage apparatus to be equipped with two (2) CPUs by employing the dual-configuration processors. If the control module is equipped with two (2) CPUs in this way, by executing programs with the two (2) CPUs, the firmware functions can be duplicated and achieved for system control managing the status of the entire system, input/output control processing input/output requests from servers to user volumes via cache control, maintenance control operated by instructions from a service processor and the like, and the processing performance can be expected to be improved as is the case with installing two (2) conventional one-CPU control modules.

However, if a control module of a storage apparatus is equipped with two (2) CPUs, a configuration control table is deployed on a shared memory of the both CPUs, resulting in the following problem. Between a system control task including configuration information management and an input/output control task, the system control task has a higher task priority. Therefore, in the conventional one (1) CPU, when the system control task is rewriting the configuration table, the input/output control task is not operated and does not refer to the configuration table being rewritten. However, if the configuration table is deployed on a shared memory of the both CPUs, when a main CPU is rewriting the configuration table, although the input/output control task of the main CPU can not be operated, the input/output control task of a sub CPU can be operated. This means that an input/output control unit can refer to the partially rewritten information of the configuration table, and by referring to the partially rewritten conflicted status, malfunction may occur.

### SUMMARY OF THE INVENTION

According to the present invention there are provided a storage device, and a configuration information management method and program for prevent malfunction by inhibiting reference associated with the input/output control task of the sub CPU when the main CPU is rewriting the configuration table.

(Exclusive Control by Executing High-Priority Control Unit)

The present invention is directed to a storage apparatus (RAID apparatus) comprising a first processing unit (main CPU) including, as execution targets, a first input/output control unit which refers to configuration information to execute input/output processing of a volume and a configuration management unit which is included in a system control unit and which manages configuration information; a second processing unit including, as execution targets, a second input/output control unit which refers to the configuration information to execute input/output processing of another volume and a higher-priority control unit which has an execution priority higher than the second input/output control unit; and a shared memory which is allocated with a configuration table storing the configuration information. In such a storage apparatus, the present invention is characterized in that it further comprises a configuration information change control unit which, when receiving a configuration information change instruction, changes configuration information of the configuration table 48 while the second input/output control unit is inhibited from referring to the configuration table by forcing the second processing unit (sub CPU) to execute processing of the higher-priority control unit, and allows the second processing unit to terminate processing of the higher-priority control unit with completion of the change of the configuration information.

In this case, the higher-priority control unit is a system control unit managing the entire system, and, when receiving the configuration information change instruction, the configuration information change control unit turns on a in-rewrite flag of the configuration table, turns off a second processing unit reception flag, then notifies the second processing unit of start of rewrite of the configuration information, changes the configuration information of the configuration table when detecting that the second processing unit reception flag is turned on in accompaniment with execution of processing of the system control unit by the second processing unit, and turns off the in-rewrite flag with completion of the change of the configuration information to force the second processing unit to terminate the processing of the system control unit.

The higher-priority control unit is a command relay control unit relaying commands between a system control unit managing the entire system and the second input/output control unit, and, when receiving the configuration information change instruction, the configuration information change control unit turns on a in-rewrite flag of the configuration table, turns off a second processing unit reception flag, then notifies the second processing unit of start of rewrite of the configuration information, changes the configuration information of the configuration table when detecting that the second processing unit reception flag is turned on in accompaniment with execution of processing of the command relay control unit by the second processing unit, and turns off the in-rewrite flag with completion of the change of the configuration information to force the second processing unit to terminate the processing of the command relay control unit.

The higher-priority control unit is a command relay control unit relaying commands between a system control unit managing the entire system and the second input/output control unit, and, when receiving the configuration information change instruction, the configuration information change control unit acquires a semaphore, then changes the configuration information of the configuration table during the reference of the second input/output processing unit to the configuration table is inhibited by forcing the command relay control unit to execute semaphore-acquisition processing with the second processing unit, releases the semaphore with completion of the change of the configuration information to allow the command relay control unit of the second processing unit to acquire the semaphore, and then forcing the semaphore-acquisition processing to be terminated.

The higher-priority control unit is a command relay control unit relaying commands between a system control unit managing the entire system and the second input/output control unit, and, when receiving the configuration information change instruction, the configuration information change control unit changes the configuration information of the configuration table during the reference of the second input/output processing unit to the configuration table is inhibited by forcing the command relay control unit to execute the relay queue readout processing with the second processing unit and forces the command relay control unit of the second processing unit to terminate the relay queue readout processing by writing completion of the change of the configuration information into the relay queue.

The higher-priority control unit is an exclusive dedicated task control unit provided for exclusive dedicated task processing, and, when receiving the configuration information change instruction, the configuration information change control unit turns on a in-rewrite flag of the configuration table, turns off a second processing unit reception flag, then notifies the second processing unit of start of rewrite of the configuration information, changes the configuration information of the configuration table when detecting that the second processing unit reception flag is turned on in accompaniment with execution of processing of the exclusive dedicated task control unit by the second processing unit, and turns off the in-rewrite flag with completion of the change of the configuration information to force the second processing unit to terminate the processing of the exclusive dedicated task control unit.

The present invention is characterized by a configuration information management method in a storage apparatus comprising a first processing unit comprising, as execution targets, a first input/output control unit which refers to configuration information to execute input/output processing of a volume and a configuration management unit which manages the configuration information; a second processing unit comprising, as execution targets, a second input/output control unit which refers to the configuration information to execute input/output processing of another volume and a higher-priority control unit which has an execution priority higher than the second input/output control unit; and a shared memory which is allocated with a configuration table storing the configuration information, the configuration information management method comprising a reference inhibition step of inhibiting reference of the second input/output control unit to the configuration table by forcing the second processing unit to execute processing of the higher-priority control unit when receiving the configuration information change instruction; a configuration information change step of changing the configuration information of the configuration table during the reference to the configuration table is inhibited; and a reference inhibition release step of forcing the second processing unit to terminate the processing of the higher-priority control unit with completion of the change of the configuration information.

The present invention is characterized by a configuration information management program operable to drive a computer constituting a first processing unit of a storage apparatus, the storage apparatus comprising the first processing unit including, as execution targets, a first input/output control unit and a configuration management unit which manages the configuration information; a second processing unit including, as execution targets, a second input/output control unit and a higher-priority control unit which has an execution priority higher than the second input/output control unit; and a shared memory which is allocated with a configuration table, to execute:

a reference inhibition step of inhibiting reference of the second input/output control unit to the configuration table by forcing the second processing unit to execute processing of the higher-priority control unit when receiving the configuration information change instruction;

a configuration information change step of changing the configuration information of the configuration table during the reference to the configuration table is inhibited; and

a reference inhibition release step of forcing the second processing unit to terminate the processing of the higher-priority control unit with completion of the change of the configuration information.

(Individual Table Configuration)

The present invention is characterized by a storage apparatus comprising a first processing unit including, as execution targets, a first input/output control unit and a configuration management unit; and a second processing unit including, as an execution target, a second input/output control unit, wherein the storage apparatus is comprised of:

a shared memory which is allocated with a first configuration table storing the configuration information referred to by the first processing unit and a second configuration table storing the configuration information referred to by the second processing unit; and

a configuration information change control unit which changes the configuration information of the first configuration table when receiving a configuration information change instruction and then distributes the configuration information change instruction to the sub processor to change the configuration information of the second configuration table.

The present invention is characterized by a configuration information management method of a storage apparatus comprising a first processing unit including, as execution targets, a first input/output control unit and a configuration management unit; and a second processing unit including, as an execution target, a second input/output control unit, the method comprising:

a table allocation step of allocating into a shared memory a first configuration table storing the configuration information referred to by the first processing unit and a second configuration table storing the configuration information referred to by the second processing unit; and

a configuration change step of changing the configuration information of the first configuration table when receiving a configuration information change instruction and then distributing the configuration information change instruction to the second processing unit to change the configuration information of the second configuration table.

The present invention is characterized by a configuration information management program operable to drive a computer constituting a first processing unit of a storage apparatus comprising the first processing unit including, as execution targets, a first input/output control unit and a configuration management unit; and a second processing unit including, as an execution target, a second input/output control unit, to execute:

a table allocation step of allocating into a shared memory a first configuration table storing the configuration information referred to by the first processing unit and a second configuration table storing the configuration information referred to by the second processing unit; and

a configuration change step of changing the configuration information of the first configuration table when receiving a configuration information change instruction and then distributing the configuration information change instruction to the second processing unit to change the configuration information of the second configuration table.

(Duplex Table)

The present invention is characterized by a storage apparatus comprising a first processing unit including, as execution targets, a first input/output control unit and a configuration management unit; and a second processing unit including, as an execution target, a second input/output control unit, wherein the storage apparatus is comprised of:

a shared memory which is allocated with a first configuration table and a second configuration table in a mirror configuration individually storing the configuration information; and

a configuration information change control unit which sets a reference pointer to the second configuration table to change the configuration information of the first configuration table and subsequently sets a reference pointer to the first configuration table to change the configuration information of the second configuration table, when receiving a configuration information change instruction.

The present invention is characterized by a configuration information management method of a storage apparatus comprising a first processing unit including, as execution targets, a first input/output control unit and a configuration management unit; and a second processing unit including, as an execution target, a second input/output control unit, wherein the method comprising:

a table allocation step of allocating into a shared memory a first configuration table and a second configuration table in a mirror configuration individually storing the configuration information; and

a configuration information change step of, when receiving a configuration information change instruction, setting a reference pointer to a change position of the second configuration table to change the configuration information at the same change position of the first configuration table and subsequently setting a reference pointer to a change position of the first configuration table to change the configuration information at the same change position of the second configuration table.

The present invention is characterized by a configuration information management program operable to drive a computer constituting a first processing unit of a storage apparatus comprising the first processing unit including, as execution targets, a first input/output control unit and a configuration management unit; and a second processing unit including, as an execution target, a second input/output control unit, to execute:

a table allocation step of allocating into a shared memory a first configuration table and a second configuration table in a mirror configuration individually storing the configuration information; and

a configuration information change step of, when receiving a configuration information change instruction, setting a reference pointer to a change position of the second configuration table to change the configuration information at the same change position of the first configuration table and subsequently setting a reference pointer to a change position of the first configuration table to change the configuration information at the same change position of the second configuration table.

(Exclusive Control by Disconnection Notification)

The present invention is characterized by a storage apparatus comprising a first processing unit including, as execution targets, a first input/output control unit and a configuration management unit; a second processing unit including, as an execution target, a second input/output control unit; and a shared memory which is allocated with a configuration table,

wherein the storage apparatus is provided with a configuration information change control unit which instructs discontinuation processing for forcing the second processing unit to complete input/output requests already accepted and not to accept new inputs/outputs when receiving a configuration information change instruction, which then changes the configuration information of the configuration table and which instructs the second processing unit to resume the processing with completion of the change of the configuration information.

The present invention is characterized by a configuration information management method of a storage apparatus comprising a first processing unit including, as execution targets, a first input/output control unit and a configuration management unit; a second processing unit including, as an execution target, a second input/output control unit; and a shared memory which is allocated with a configuration table, the method comprising:

an interruption instruction step of, when receiving a configuration information change instruction, instructing the second processing unit of discontinuation processing for forcing the second processing unit to complete input/output requests already accepted and not to accept new inputs/outputs;

a configuration information change step of changing the configuration information of the configuration table after the instruction of the interruption processing;

a resume instruction step of instructing the second processing unit to resume the processing with completion of the change of the configuration information.

The present invention is characterized by a configuration information management program operable to drive a computer constituting a first processing unit of a storage apparatus comprising a first processing unit including, as execution targets, a first input/output control unit and a configuration management unit; a second processing unit including, as an execution target, a second input/output control unit; and a shared memory which is allocated with a configuration table, to execute:

an interruption instruction step of, when receiving a configuration information change instruction, instructing the second processing unit of discontinuation processing for forcing the second processing unit to complete input/output requests already accepted and not to accept new inputs/outputs;

a configuration information change step of changing the configuration information of the configuration table after the instruction of the interruption processing;

a resume instruction step of instructing the second processing unit to resume the processing with completion of the change of the configuration information.

(Exclusive Control When Referring to Table)

The present invention is characterized by a storage apparatus comprising a first processing unit including, as execution targets, a first input/output control unit and a configuration management unit; a second processing unit including, as an execution target, a second input/output control unit; and a shared memory which is allocated with a configuration table,

wherein the storage apparatus is provided with a configuration information change control unit which inhibits the reference of the second input/output control unit by setting exclusive control information to the configuration table when receiving a configuration information change instruction, which then changes the configuration information of the configuration table and which releases the setting of the exclusive control information with completion of the change of the configuration information.

The present invention is characterized by a configuration information management method of a storage apparatus comprising a first processing unit including, as execution targets, a first input/output control unit and a configuration management unit; a second processing unit including, as an execution target, a second input/output control unit; and a shared memory which is allocated with a configuration table, the method comprising:

an exclusive control setting step of, when receiving a configuration information change instruction, setting exclusive control information to the configuration table to inhibit the reference of the second input/output control unit;

a configuration information change step of changing the configuration information of the configuration table with the exclusive control information being set; and

an exclusive control release step of releasing the setting of the exclusive control information with completion of the change of the configuration information.

The present invention is characterized by a configuration information management program operable to drive a computer making up a first processing unit of a storage apparatus comprising a first processing unit including, as execution targets, a first input/output control unit and a configuration management unit; a second processing unit including, as an execution target, a second input/output control unit; and a shared memory which is allocated with a configuration table, to execute:

an exclusive control setting step of, when receiving a configuration information change instruction, setting exclusive control information to the configuration table to inhibit the reference of the second input/output control unit;

a configuration information change step of changing the configuration information of the configuration table with the exclusive control information being set; and

an exclusive control release step of releasing the setting of the exclusive control information with completion of the change of the configuration information.

According to the present invention, when rewriting a configuration table deployed on a shared memory from a main CPU as a first processing unit, execution of processing for an input/output control unit of a sub CPU as a second processing unit is inhibited by:

(1) executing processing for a higher-priority control unit with a higher priority (executing processing for a system control unit, a command relay unit or an exclusive dedicated task control unit);

(2) executing processing for the command relay unit with a higher priority (an agent operation, semaphore acquisition, and message queue utilization);

(3) individually allocating the configuration table;

(4) mirroring (duplicating) the configuration table;

(5) performing a suspend notification (interruption notification) of the input/output control; or

(6) performing flag exclusion control when referring to the configuration table,

and thereby it can be ensured that malfunction is prevented from occurring due to the sub CPU referring to a conflicted status of the configuration table partially rewritten by the main CPU, and a credible storage apparatus can be achieved when the processing performance is improved by dual CPU configuration.

The above and other objects, features and advantages of the present invention will become more apparent from the following detailed description with reference to the drawings.

### BRIEF DESCRIPTION OF THE DRAWINGS

FIG. 1 is a block diagram of hardware configuration of RAID apparatus to which the present invention is applied;

FIGS. 2A and 2B are block diagrams of functional structure of RAID apparatus according to the present invention;

FIG. 3 is an explanatory view of configuration table of FIGS. 2A and 2B;

FIGS. 4A and 4B are explanatory views of first embodiment of the present invention, inhibiting table reference of input/output control by making the sub CPU execute system control task when rewriting configuration table;

FIGS. 5A and 5B are flowcharts of control processing of main CPU and sub CPU according to first embodiment of FIGS. 4A and 4B;

FIGS. 6A and 6B are explanatory views of second embodiment of the present invention, inhibiting table reference of input/output control by making sub CPU execute processing of maintenance agent when rewriting configuration table;

FIGS. 7A and 7B are flowcharts of control processing of main CPU and sub CPU according to second embodiment of FIGS. 6A and 6B;

FIGS. 8A and 8B are explanatory views of third embodiment of the present invention, inhibiting table reference by input/output control of sub CPU by acquiring semaphore when rewriting configuration table;

FIGS. 9A and 9B are flowcharts of control processing of main CPU and sub CPU according to third embodiment of FIGS. 8A and 8B;

FIGS. 10A and 10B are explanatory views of fourth embodiment of the present invention, inhibiting table reference by input/output control of sub CPU by utilizing message queue;

FIGS. 11A and 11B are flowcharts of control processing of main CPU and sub CPU according to fourth embodiment of FIGS. 10A and 10B;

FIGS. 12A and 12B are explanatory views of fifth embodiment of the present invention, inhibiting table reference of input/output control by making sub CPU execute exclusive dedicated task control when rewriting configuration table;

FIGS. 13A and 13B are flowcharts of control processing of main CPU and sub CPU according to fifth embodiment of FIGS. 12A and 12B;

FIGS. 14A and 14B are explanatory views of sixth embodiment of the present invention, inhibiting reference during table Rewrite by disposing configuration table in shared memory for each of main CPU and sub CPU;

FIG. 15 is a flowchart of configuration information change processing according to sixth embodiment of FIGS. 14A and 14B;

FIGS. 16A and 16B are explanatory views of seventh embodiment of the present invention, inhibiting reference during table Rewrite by mirroring configuration table to provide two configuration tables in shared memory;

FIGS. 17A and 17B are explanatory views of processing for referring to one configuration table while the other configuration table is rewritten, according to the seventh embodiment of FIGS. 16A and 16B;

FIG. 18 is a flowchart of configuration information change processing according to seventh embodiment of FIGS. 16A and 16B;

FIG. 19 is an explanatory view of eighth embodiment of the present invention, inhibiting reference during table Rewrite by notifying sub CPU of suspend to discontinue acceptance of input/output request when changing configuration table;

FIG. 20 is a flowchart of main CPU processing according to eighth embodiment of FIG. 19;

FIG. 21 is a flowchart of sub CPU processing according to eighth embodiment of FIG. 19;

FIGS. 22A and 22B are explanatory views of ninth embodiment of the present invention, inhibiting reference during table rewrite by acquiring lock with exclusive flag when changing configuration table; and

FIG. 23 is a flowchart of configuration information change processing according to ninth embodiment of FIGS. 22A and 22B.

### DETAILED DESCRIPTION OF THE PREFERRED EMBODIMENT

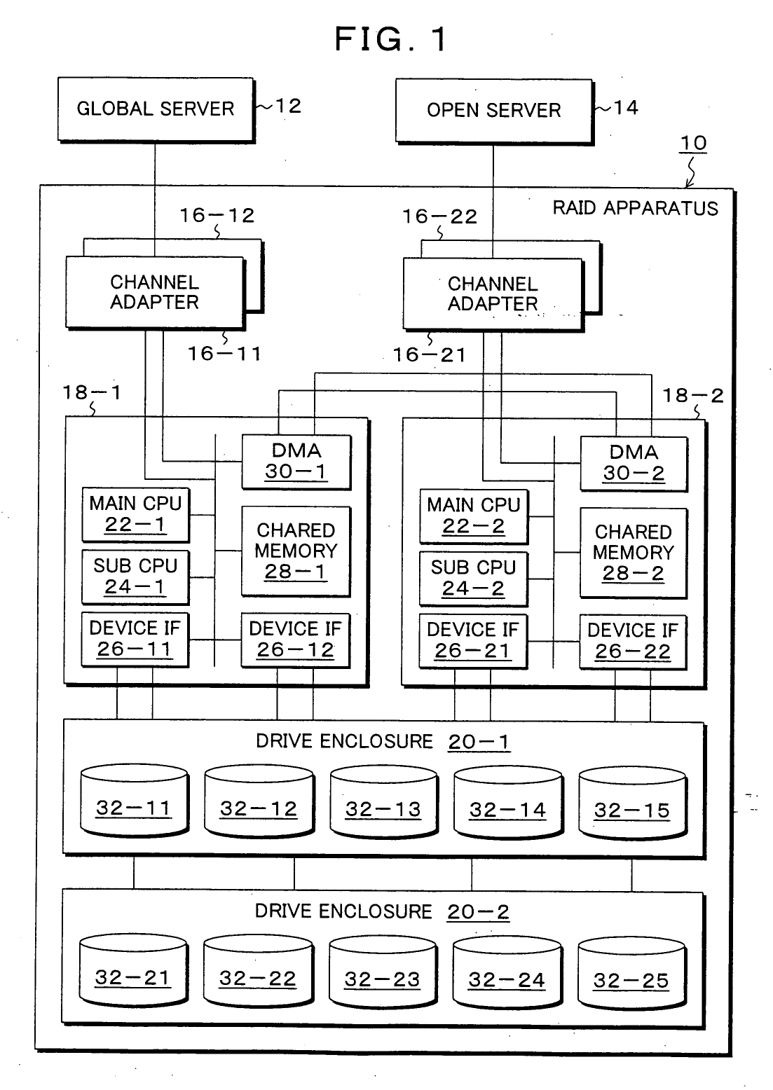

FIG. 1 is a block diagram of a hardware apparatus of a RAID apparatus to which the present invention is applied. In FIG. 1, the RAID apparatus 10 is comprised of channel adapters 16-11 to 16-22, control modules 18-1, 18-2 and drive enclosures 20-1, 20-2. The RAID apparatus 10 is connected to a global server as a higher-level apparatus via the channel adapter 16-11 and is connected to an open server 14 via the channel adapter 16-22. The control modules 18-1 and 18-2 have the same configuration and are provided with main CPUs 22-1, 22-2 as first processing units, sub CPUs 24-1, 24-2 as second processing units, device interfaces 26-11, 26-12, 26-21, 26-22, shared memories 28-1, 28-2 and DMA processing units 30-1, 30-2. The drive enclosures 20-1, 20-2 are provided with disk apparatuses 32-11 to 32-15, 32-21 to 32-25 using hard disk drives. Although a minimum configuration is taken as an example of the RAID apparatus 10, in a maximum configuration, the two (2) control modules 18-1, 18-2 can be expanded to eight (8) modules, and the drive enclosures can also be expanded by using expanded chassis. Taking the control module 18-1 as an example of the control modules 18-1 and 18-2, the control module 18-1 of the present invention is provided with two (2) CPUs which are the main CPU 22-1 and the sub CPU 24-1, and one (1) control module 18-1 effectively achieves processing performance equivalent to the case of providing two (2) control modules. The memory provided on the control module 18-1 is used as a shared memory of the main CPU 22-1 and the sub CPU 24-1, and the shared memory 28-1 reserves an area used as a cache memory and an allocation area for the configuration table which is a target of configuration management covered by the present invention.

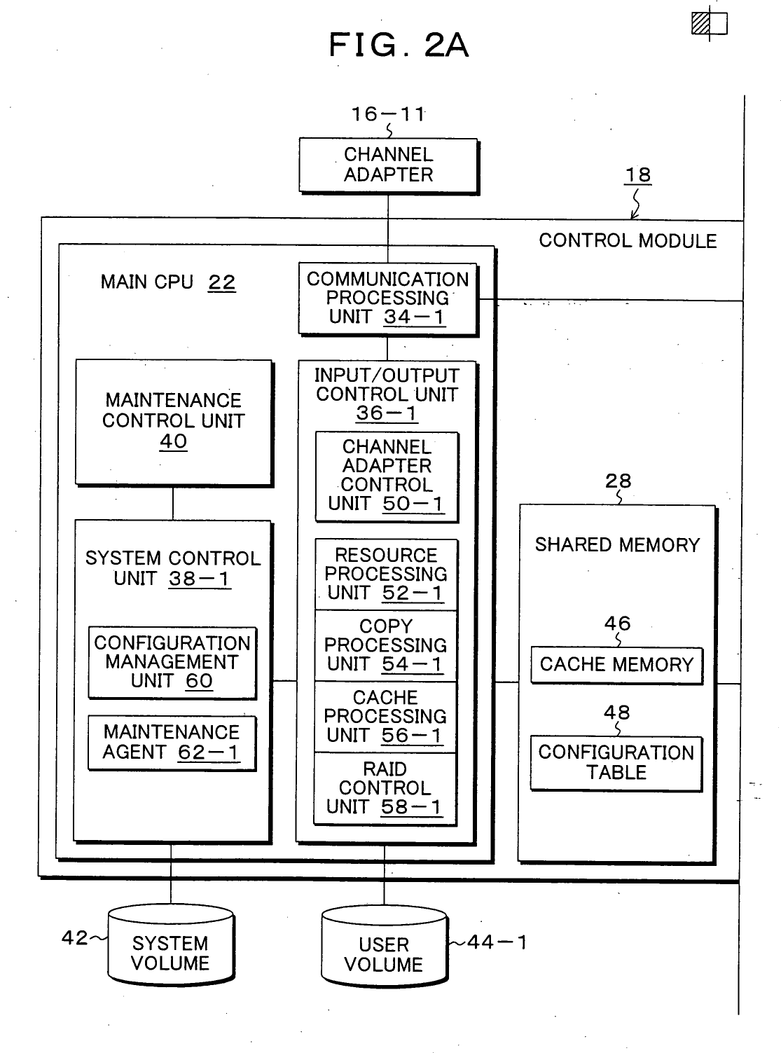

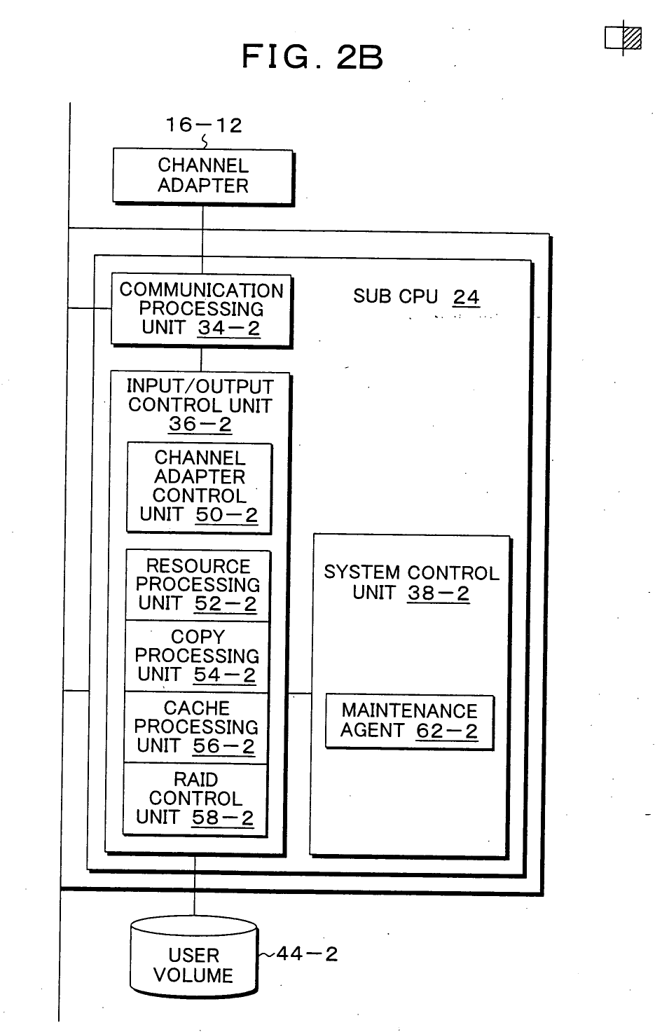

FIGS. 2A and 2B are block diagrams of a functional structure of the RAID apparatus according to the present invention and, since each of the control modules 18-1, 18-2 of FIG. 1 has the same configuration, the functional structure of the control module 18 is shown in FIGS. 2A and 2B. In FIGS. 2A and 2B, the control module 18 is provided with the main CPU 22 and the sub CPU 24 which execute programs to achieve functions of the RAID apparatus. The main CPU 22 is provided with a communication processing unit 34-1, an input/output control unit 36-1, a system control unit 38-1 and a maintenance control unit 40. On the other hand, the sub CPU 24 is provided with a communication processing unit 34-2, an input/output control unit 36-2 and a system control unit 38-2 and is not provided with the maintenance control unit. The communication processing units 34-1, 34-2 performs communication between the control modules via the channel adapters 16-11, 16-12, inter-CPU communication between the main CPU 22 and the sub CPU 24 and the like. The input/output control units 36-1, 36-2 process input/output requests from higher-level servers. Therefore, the input/output control unit 36-1 is provided with a user volume 44-1 and the input/output control unit 36-2 is provided with a user volume 44-2. The input/output control units 36-1, 36-2 are provided with channel adapter control units 50-1, 50-2, which act as fiber channel drivers or iSCSI drivers for performing communication with the global server 12 or the open server 14 connected to the channel adapters 16-11, 16-12 via the communication processing units 34-1, 34-2. The input/output control units 36-1, 36-2 is provided with a resource processing unit 52-1, 52-2, a copy processing unit 54-1, 54-2, a cache processing unit 56-1, 56-2 and a RAID control unit 58-1, 58-2, which have a layer configuration as a basic control unit. The resource processing unit 52-1, 52-2 exclude and monitor the input/output requests from the higher-level apparatuses. The copy processing units 54-1, 54-2 performs copy processing in units of volume with other RAID apparatuses inside and outside of the RAID apparatus. The cache processing units 56-1, 56-2 manage cache memories for read requests and write requests from the higher-level apparatuses, determine hits and mishits of the read or write requests, execute schedules of staging and write-back and the like. The RAID control units 58-1, 58-2 control input/output processing for the disk enclosure side on the each RAID level. In this example, for example, the RAID apparatus 58-1 executes input/output processing for the user volume 44-1 on the RAID level 4 and the RAID apparatus 58-2 performs input/output processing for the user volume 44-2 on the RAID level 5. The system control unit 38-1 provided on the main CPU 22 manages the state of the entire RAID apparatus. The system control in the RAID apparatus is basically performed by the system control unit 38-1 of the main CPU 22, and although the sub CPU 24 is also provided with the system control unit 38-2, the system control unit 38-2 is exceptionally operated only when it is needed to operate hardware coupled to the sub CPU 24. The system control unit 38-1 of the main CPU 22 is provided with a configuration management unit 60 performing change processing of the configuration table covered by the present invention. Besides the function of the configuration management unit 60, the system control unit 38-1 is provided with: power control for controlling power-on and power off sequences and power recovery processing; a RAS control unit for identifying a failure site to perform isolation and reincorporation of the failure site when an error occurs within the apparatus; a RAID recovery unit for controlling allocation of a hot-spare disk (backup disk) and state control of the RAID group at the time of a failure or generation and supplement of the disk; an activated processing unit for controlling hot swap and hot expansion or reduction processing of components other than the disk; and a system management unit for synchronizing alarms for a power supply, temperatures and the like and events notified from a mount information service processor of components and the like within the apparatus to activate necessary processing. The system control unit 38-2 on the sub CPU side 24 is allocated with some functions of each control unit provided on the system control unit 38-1 of the main CPU 22.

The system control units 38-1, 38-2 are provided with maintenance agents 62-1, 62-2. The maintenance agents 62-1, 62-2 are located between the system control units 38-1, 38-2 and the input/output control unit 36-1, 36-2 and act as command relay processing units for relaying commands therebetween. On the main CPU 22 side, the maintenance agent 62-1 also relays commands between the maintenance control unit 40 and the input/output control unit 36-1. This is caused by that the formats of the commands for input/output control units 36-1, 36-2 are different between the system control unit 38-1, 38-2 and the maintenance control unit 40 sides. The maintenance control unit 40 of the main CPU 22 executes various maintenance tasks necessary for maintenance management of the RAID apparatus. A cache memory 46 and a configuration table 48 are deployed on the shared memory 28 used by both the main CPU 22 and the sub CPU 24. The configuration management unit 60 provided on the system control unit 38-1 of the main CPU uses the configuration table 48 of the shared memory 28 to manage configuration information of the apparatus. The configuration management unit 60 is equipped with following processing functions, for example:

(1) configuration reference processing;

(2) configuration change processing; and

(3) configuration distribution processing.

The configuration reference processing is a function for analyzing the content of the requested configuration reference command and reading the configuration information of the apparatus from the configuration table 48 to process and retrieve the information in accompaniment with specified format. The configuration change processing is a function for analyzing the content of the requested configuration reference command and changing the configuration information of the apparatus stored in the configuration table 48. The configuration distribution processing is a function for distributes the configuration information of the apparatus in the configuration table 48 changed in the configuration change processing to other layers or other control modules in the same apparatus. The configuration change request to the configuration management unit 60 is issued from the CGI (Common Gateway Interface) program to the configuration management unit 60 if the configuration table is needed to be changed due to changes in the setting of the apparatus or the status of the apparatus and is notified to the configuration management unit 60 of the system control unit 38-1 through a maintenance task in the maintenance control unit 40. When receiving the command requesting configuration change, the configuration management unit 60 performs the configuration change rewriting the configuration table 48 depending on the command and distributes the changed configuration information to appropriate destinations after the configuration change is completed.

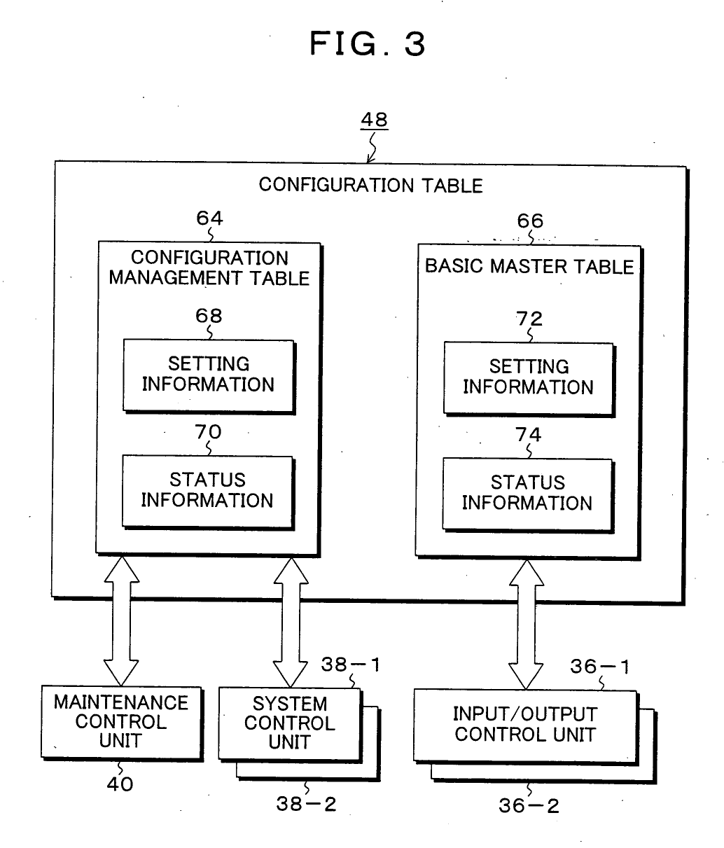

FIG. 3 is an explanatory view of the configuration table provided on the shared memory 28. In FIG. 3, the configuration table 48 consists of a configuration management table 64 and a basic master table 66. The configuration management table 64 is a table mainly used by the maintenance control unit 40 and the system control units 38-1, 38-2 of FIGS. 2A and 2B. The basic master table 66 is a table collecting configuration information needed for operation of the basic master table 66 and the input/output control units 36-1, 36-2. The information in the configuration management table 64 is divided into setting information 68 and status information 70. The setting information 68 is information of a component configuration, RAID configuration and the like set by a user application, and the status information 70 is information representing a status of each component which indicates current information. In regard to this, the basic master table 66 also stores setting information 72 and status information 74, and in the case of the basic master table 66, the setting information 72 and the status information 74 are information needed for operation of the input/output control units 36-1, 36-2.

Referring again to FIGS. 2A and 2B, the configuration management unit 60 of the system control unit 38-1 provided on the main CPU 22 is provided with a function as a configuration information change processing unit which performs exclusive control for preventing malfunction due to reference to the configuration information being rewritten by the input/output control unit 36-2 of the sub CPU 24 at the time of the configuration change processing rewriting the configuration information of the configuration table 48. As the function of the configuration information change processing unit, processing of any one of (1) to (5) will be performed in the present invention.

(1) When the main CPU 22 changes the configuration table 48, the sub CPU 24 is forced to perform processing of a higher-priority control unit having a priority higher than the input/output control unit 36-2. The processing of the higher-priority control unit is achieved by executing the second system control unit 38-2 or by executing the maintenance agent 62-2.

(2) The configuration table used by the main CPU and the configuration table used by the sub CPU is individually allocated to the shared memory 28.

(3) The malfunction due to the reference during rewrite is prevented by mirroring the configuration table on the shared memory 28 rewritten by the main CPU 22 while forcing the sub CPU 24 to refer to the other configuration table.

(4) Prior to the change of the configuration table 48, the main CPU 22 performs a suspend notification (interruption notification) stopping new input/output control to the sub CPU 24 to inhibit the reference.

(5) The configuration table 48 of the shared memory 28 is provided with an exclusive flag, and the main CPU 22 acquires the exclusive flag when changing the configuration table 48 to prevent the reference by the sub CPU 24 which cannot acquire the exclusive flag.

Hereinafter, each embodiment of (1) to (5) is specifically described.

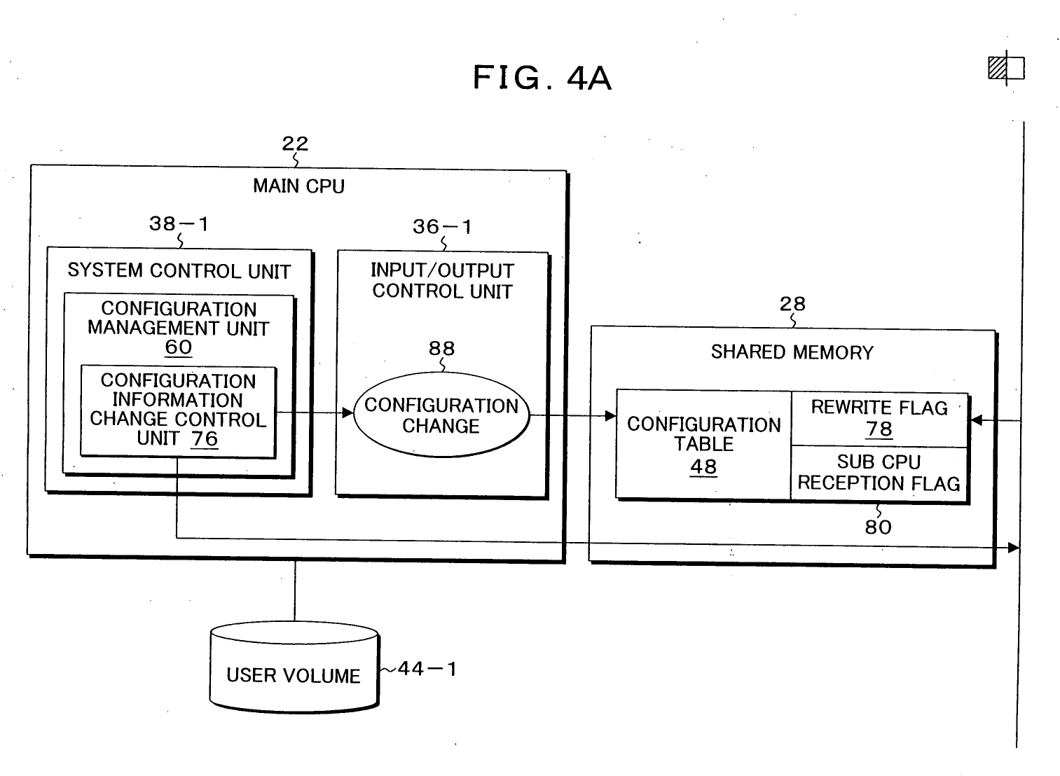

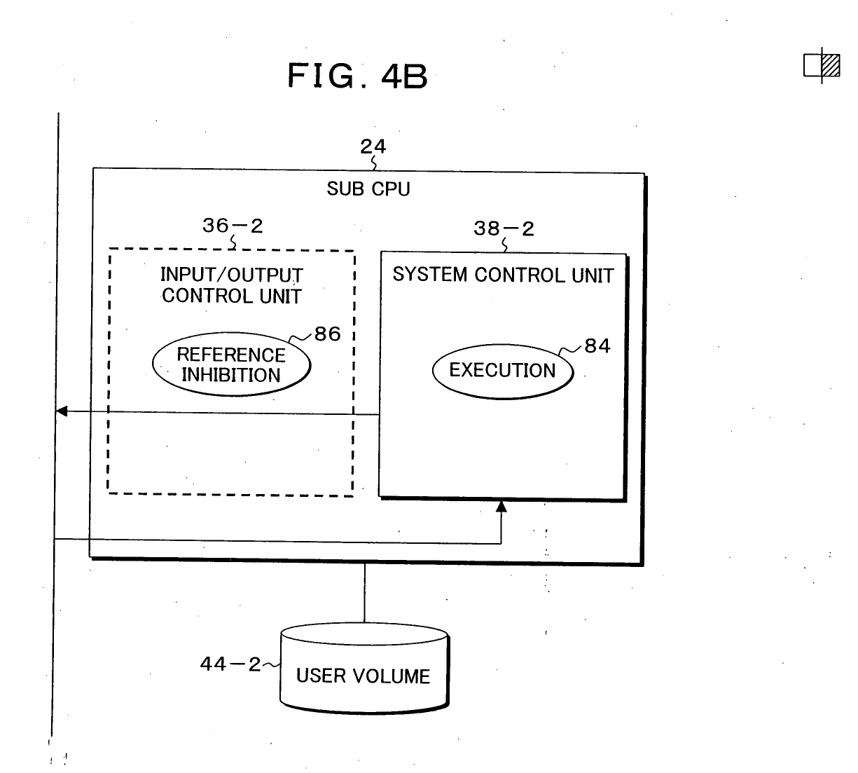

FIGS. 4A and 4B are explanatory views of a first embodiment of the present invention, which inhibits the table reference of the input/output control by forcing the sub CPU to execute a system control task when rewriting configuration table. In FIGS. 4A and 4B, a configuration information change processing unit 76 is provided in the configuration management unit 60 of the system control unit 38-1 provided on the main CPU 22. When receiving an instruction for changing the configuration information, the configuration information change processing unit 76 inhibits the reference during rewrite of the configuration table by the input/output control unit 36-2, by forcing the sub CPU 24 to execute appropriate processing of higher-priority control having a priority higher than a input/output control task of the input/output control unit 36-2. As an example of forcing the sub CPU 24 to execute the processing of the higher-priority control unit having a priority higher than the input/output control unit 36-2, the first embodiment of FIGS. 4A and 4B forces to execute the processing of the system control unit 38-2 provided on the sub CPU 24. In the RAID apparatus of the present invention, the execution priority of the control task in each CPU is set higher for the system control task than the input/output task. Therefore, by executing the processing of the system control unit 38-2 on the sub CPU 24 prior to the rewrite of the configuration table 48 on the main CPU 22, the reference to the configuration table 48 can be prevented since the processing of the input/output control unit 36-2 having a lower priority is not executed. As a specific example of forcing the sub CPU 24 to execute the processing of the system control unit 36-2, when the instruction for changing the configuration information, the configuration information change processing unit 76 turns on a in-rewrite flag provided on the shared memory 28, turns of a sub CPU reception flag 80 used by the sub CPU 24 for acknowledgement and performs a configuration information rewrite start notification 82 to the sub CPU 24. When the system control unit 36-2 becomes the state of execution 84 on the sub CPU 24 in response to the configuration information rewrite start notification 82, an acknowledgement of the received notification is sent back to the main CPU 22 by turning on the sub CPU reception flag 80 of the shared memory 28. Then, the system control unit 38-2 enters into polling processing for periodically referring to and checking a in-rewrite flag 78 of the shared memory 28. After performing the configuration rewrite start notification 82, the configuration information change processing unit 76 of the main CPU 22 monitors the sub CPU reception flag 80 of the shared memory 28, recognizes that the sub CPU reception flag 80 is turned on by the operation of the system control unit 36-2 and performs configuration change 88 to rewrite the configuration table 48. After the configuration table 48 has been rewritten, the configuration information change processing unit 76 turns on the in-rewrite flag 78 of the shared memory 28. Turning on the in-rewrite flag 78 is detected by the system control unit 38-2 of the sub CPU 24; the system control unit 38-2 terminates the execution of the processing; and the input/output control unit 36-2 goes back to a condition for enabling execution of a task.

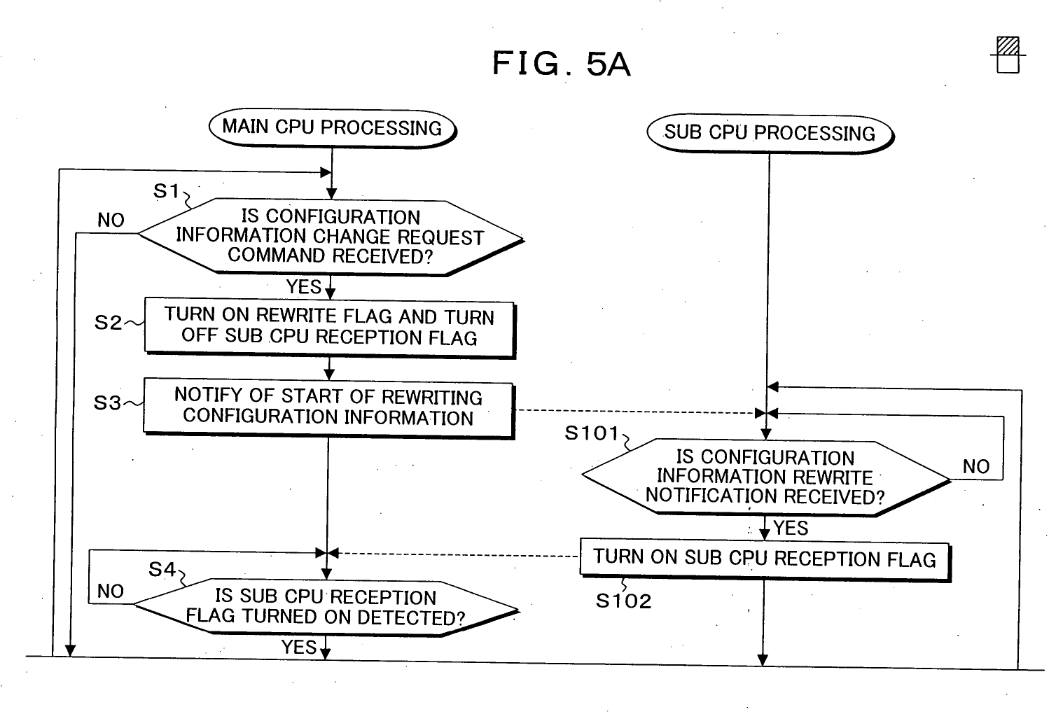

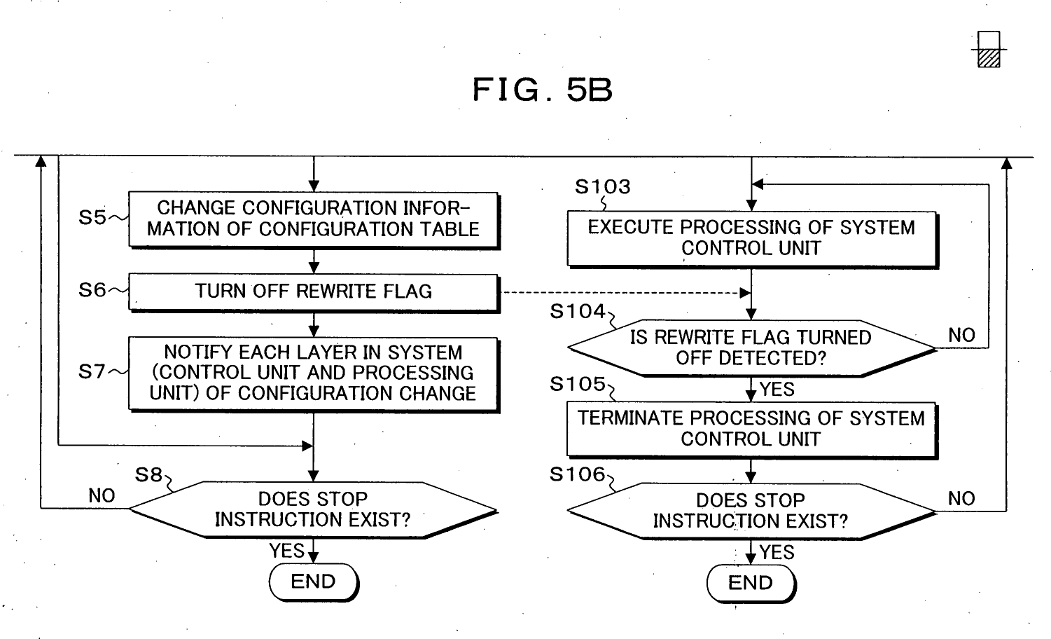

FIGS. 5A and 5B are flowcharts of the main CPU and the sub CPU according to the first embodiment of FIGS. 4A and 4B. In FIGS. 5A and 5B, the main CPU checks whether the configuration information change command is received or not in step S1, proceeds to step S2 when the command is received, turns on the in-rewrite flag on the shared memory 28 and turns off the sub CPU reception flag 80. Then, in step S3, the configuration information rewrite start notification is sent to the sub CPU. In step S101, the sub CPU checks whether the configuration information rewrite start notification is received from the main CPU, proceeds to step S102 when the notification is received and turns on the sub CPU reception flag 80 on the shared memory 28. This turning on of the sub CPU reception flag 80 is recognized by determination processing of the main CPU in step S4 which checks whether turning on of the sub CPU reception flag 80 is detected or not, and change processing is performed in step S5 for rewriting the configuration information of the configuration table. After the configuration information is changed, in step S6, the in-rewrite flag 78 on the shared memory 28 is turned off. This turning off of the in-rewrite flag 78 is determined in step S104 of the sub CPU and terminates processing of the system control unit 38-2 for polling the in-rewrite flag 78 in step S105, and thereby, the task of the input/output processing is enabled to be performed by the input/output control unit 36-2 which has a lower task priority then the system control unit 38-2. On the other hand, the main CPU turns off the in-rewrite flag 78 in step S6 and notifies each layer in the system of the changed configuration information in step S7 to terminate the series of processing. Both the main CPU and the sub CPU repeat the processing from steps S1, S101 until a stop instruction exists in steps S8, S106. In this way, in the first embodiment of FIGS. 4A and 4B, the input/output control unit 36-2 is prevented from referring to the configuration table being rewritten and the malfunction due to the reference to the configuration information during rewrite is certainly prevented by forcing the input/output control unit 36-2 provided on the sub CPU 24 to execute the task of the higher-priority control unit having the higher task priority during the configuration table is rewritten. The content of processing of the system control unit 38-2 for preventing the input/output control unit 36-1 from referring to the configuration table 48 is execution of simple polling processing monitoring that the in-rewrite flag 78 on the shared memory 28 is turned on by the change in the configuration information, and by providing such a task of the polling processing function for the in-rewrite flag 78 in the system control unit 38-2 of the sub CPU 24, the input/output control unit 36-2 can easily be excluded from the rewrite of the configuration table 48 by the main CPU 22.

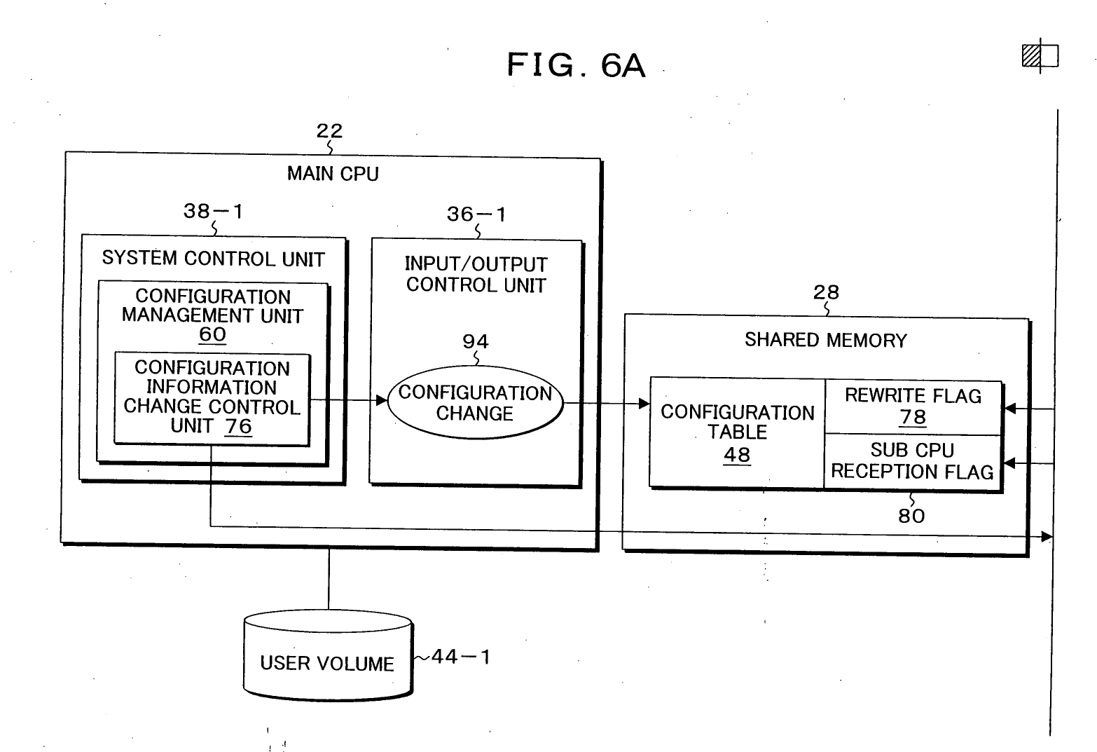

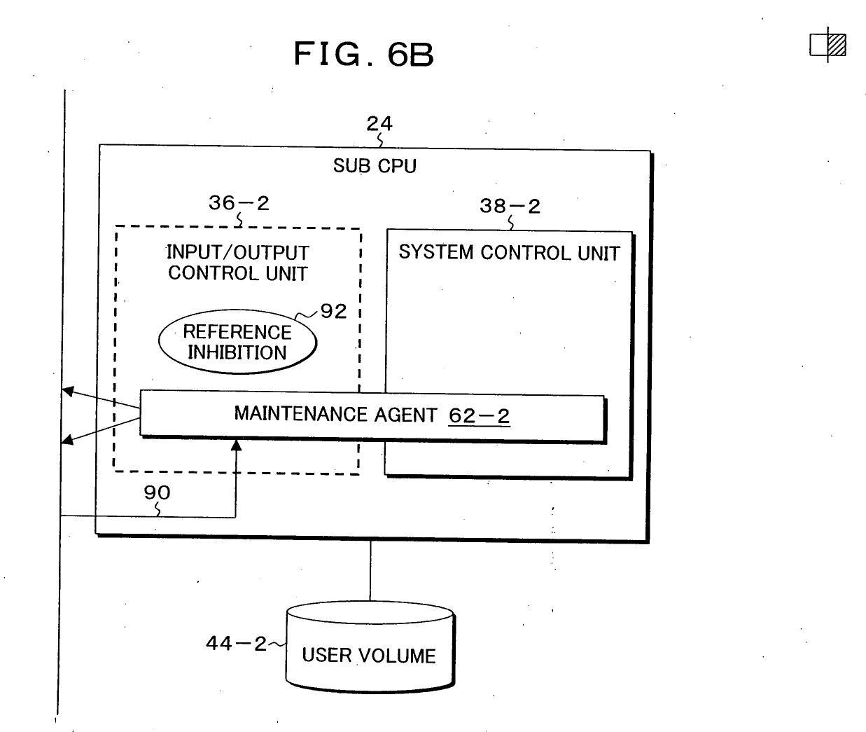

FIGS. 6A and 6B are explanatory views of a second embodiment of the present invention and the second embodiment is characterized by that the table reference of the input/output control is inhibited by forcing the sub CPU to execute maintenance agent processing while the main CPU is rewriting the configuration table. In FIGS. 6A and 6B, the configuration information change control unit 76 is provided in the configuration management unit 60 provided in the system control unit 38-1 of the main CPU, and when the configuration table 48 of the shared memory 28 is rewritten, the processing of the maintenance agent 62-2 is forced to be executed by a configuration information rewrite start notification 90 to the sub CPU 24. Since a primary function of the maintenance agent 62-2 is a command relay function between the system control unit 38-2 and the input/output control unit 36-2, the maintenance agent 62-2 has the execution priority of the control task higher than the input/output control unit 36-2. By forcing the sub CPU 24 to execute appropriate processing of the maintenance agent 62-2 while the main CPU 22 is rewriting the configuration table 48, the input/output control unit 36-2 having a lower priority of the execution task can be prevented from referring to the configuration table 48 during the rewrite. Basically, as is the case with the first embodiment of FIGS. 4A and 4B, specific processing of the configuration information change control unit 76 is performed by providing the in-rewrite flag 78 and the sub CPU reception flag 80 on the shared memory 28. In other words, when receiving the change instruction, the configuration information change control unit 76 turns on the in-rewrite flag 78 on the shared memory 28, turns off the sub CPU reception flag 80 and then issues the configuration information rewrite start notification 90 to the sub CPU 24. In response to this configuration information rewrite start notification 90, the sub CPU 24 activates the maintenance agent 62-2, and the activated maintenance agent 62-2 sends back the acknowledgement for the notification to the main CPU by turning on the sub CPU reception flag 80. Subsequently, the maintenance agent 62-2 starts polling processing for monitoring that the in-rewrite flag 78 is turned on. When detecting that the sub CPU reception flag 80 of the shared memory 28 is turned on, the configuration information change control unit 76 detects that the maintenance agent 62-2 is in the operation status on the sub CPU 24 side and rewrites the configuration table 48 with a configuration change 94. Since the maintenance agent 62-2 is operated on the sub CPU 24, the input/output control unit 36-2 having the lower priority of the execution task is not operated and is in reference inhibition status 92. After the configuration table 48 has been rewritten, the configuration information change control unit 76 turns on the in-rewrite flag of the shared memory 28. By detecting this, the maintenance agent 62-2 of the sub CPU 24 terminates the polling processing and enables the control task of the input/output control unit 36-2 to be executed.

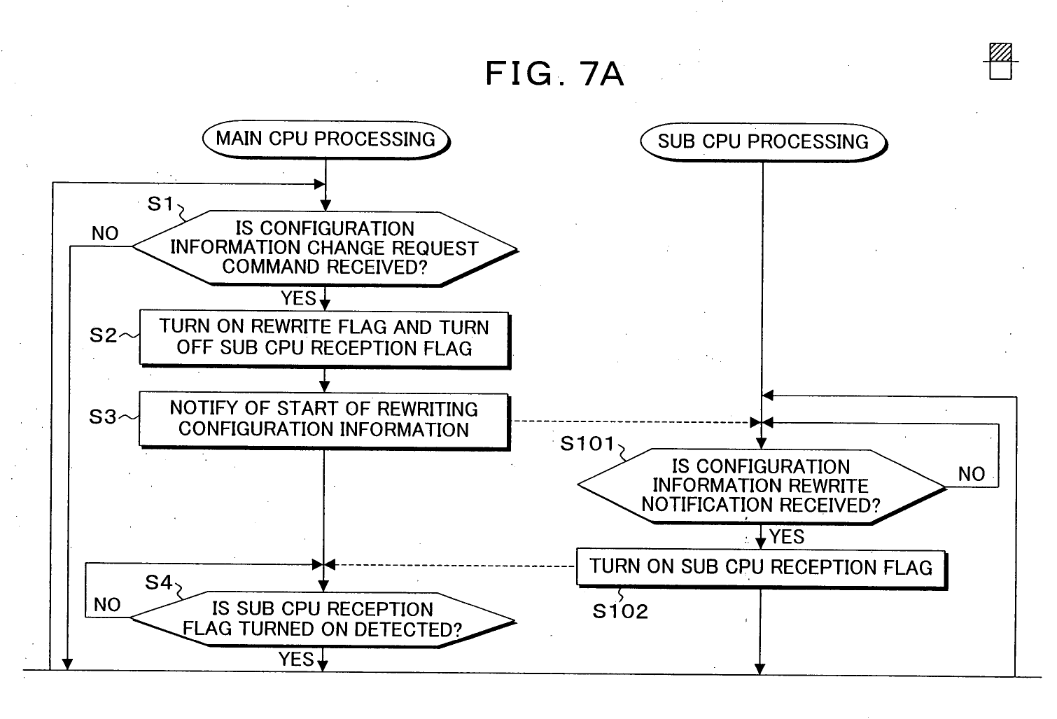

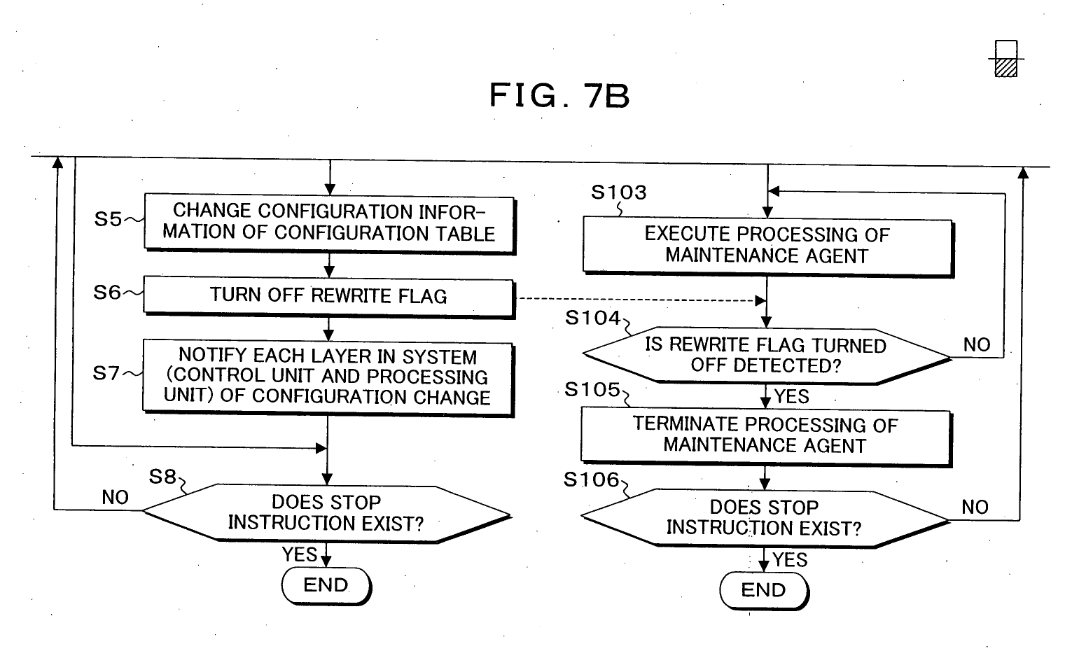

FIGS. 7A and 7B are flowcharts of the control processing of the main CPU and the sub CPU according to the second embodiment of FIGS. 5A and 5B. In FIGS. 7A and 7B, the main CPU receives the configuration information change command in step S1, turns on the in-rewrite flag 78 and turns off the sub CPU reception flag 80 in step S2. Then, in step S3, the start of the rewrite of the configuration information is notified to the sub CPU 24. In step S101, the sub CPU checks whether the configuration information rewrite start notification is received from the main CPU, proceeds to step S102 when the notification is received and turns on the sub CPU reception flag 80. Turning on of the sub CPU reception flag is detected by the main CPU in step S4, and the configuration information of the configuration table 48 is changed in step S5. During this time, the sub CPU executes processing for polling the in-rewrite flag 78 of the shared memory 28 as the processing of the maintenance agent as shown by step S103. Therefore, during the rewrite of the configuration table 48, the task of the input/output control unit 36-2 of the sub CPU 24 is not executed, and the reference to the configuration information being rewritten is inhibited. After the configuration information is changed on the main CPU, in step S6, the in-rewrite flag 78 is turned off. Turning off of the in-rewrite flag is determined in step S104 of the sub CPU; the processing of the maintenance agent is terminated in step S105; and the input/output control unit 36-2 having the lower priority of the execution task is enabled to execute processing. The main CPU turns off the in-rewrite flag 78 in step S6 and notifies each layer in the system of the changed configuration information in step S7. Both the main CPU and the sub CPU repeat the processing from steps S1, S101 until a stop instruction exists in steps S8, S106.

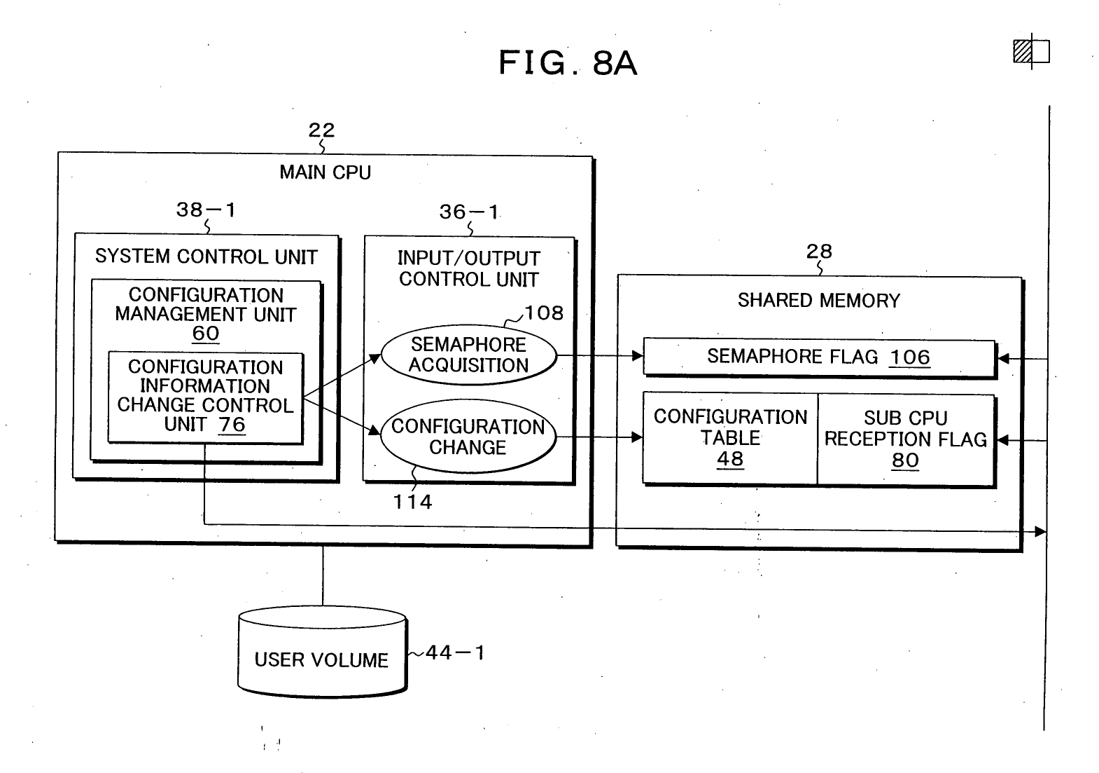

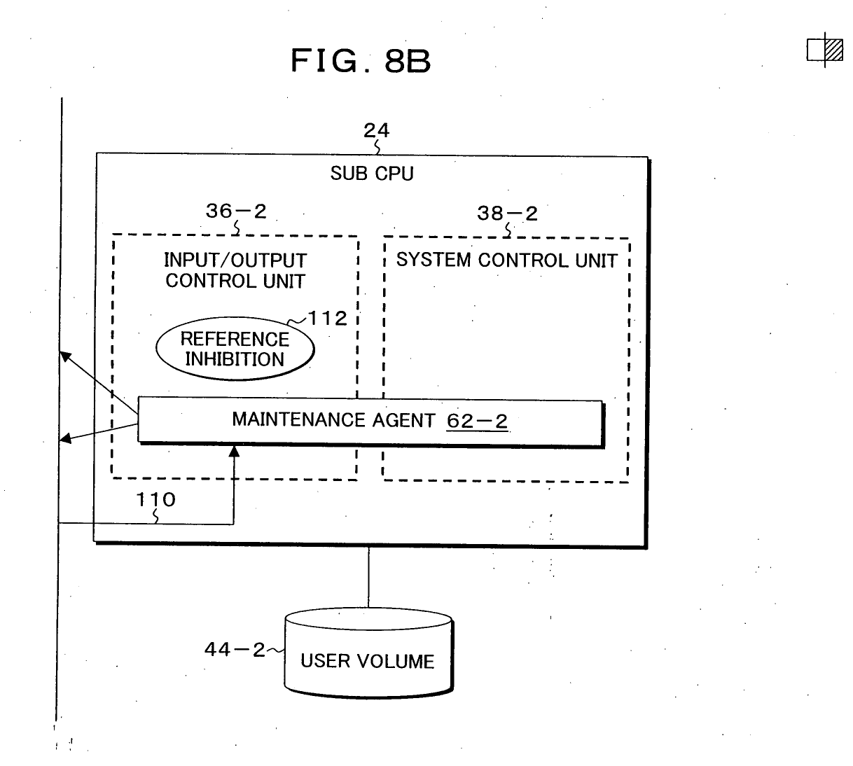

FIGS. 8A and 8B are explanatory views of a third embodiment of the present invention and the third embodiment is characterized by that the table reference of the input/output control on the sub CPU is inhibited by acquiring a semaphore as the processing of the maintenance agent when the main CPU rewrites the configuration table. In FIGS. 8A and 8B, the system control unit 38-1 of the main CPU 22 has the configuration management unit 60, and the configuration management unit 60 is provided with the configuration information change control unit 76. When receiving the configuration information change instruction, the configuration information change control unit 76 of the third embodiment performs semaphore acquisition 108 for acquiring a semaphore flag 106 of the shared memory 28 provided by OS of the main CPU 22 and then performs configuration change 114 of the configuration table 48. Specifically, when receiving the configuration information change instruction, the configuration information change control unit 76 acquires the semaphore flag 106 and issues a configuration information rewrite start notification 110 to the sub CPU 24 with the sub CPU reception flag turned off. The sub CPU 24 activates the maintenance agent 62-2 in response to the configuration information rewrite start notification 110, turns on the sub CPU reception flag 80 for acknowledgement and then performs the processing for acquiring the semaphore flag 106. However, since the semaphore flag 106 is acquired by the main CPU 22 during the rewrite of the configuration table 48, the maintenance agent 64-2 of the sub CPU 24 cannot acquire the semaphore flag 106, and while the maintenance agent 62-2 is performing the semaphore acquisition processing, the input/output control unit 36-2 having the lower execution priority is not operated and is in a reference inhibition 112 status so that the configuration table cannot be referred.

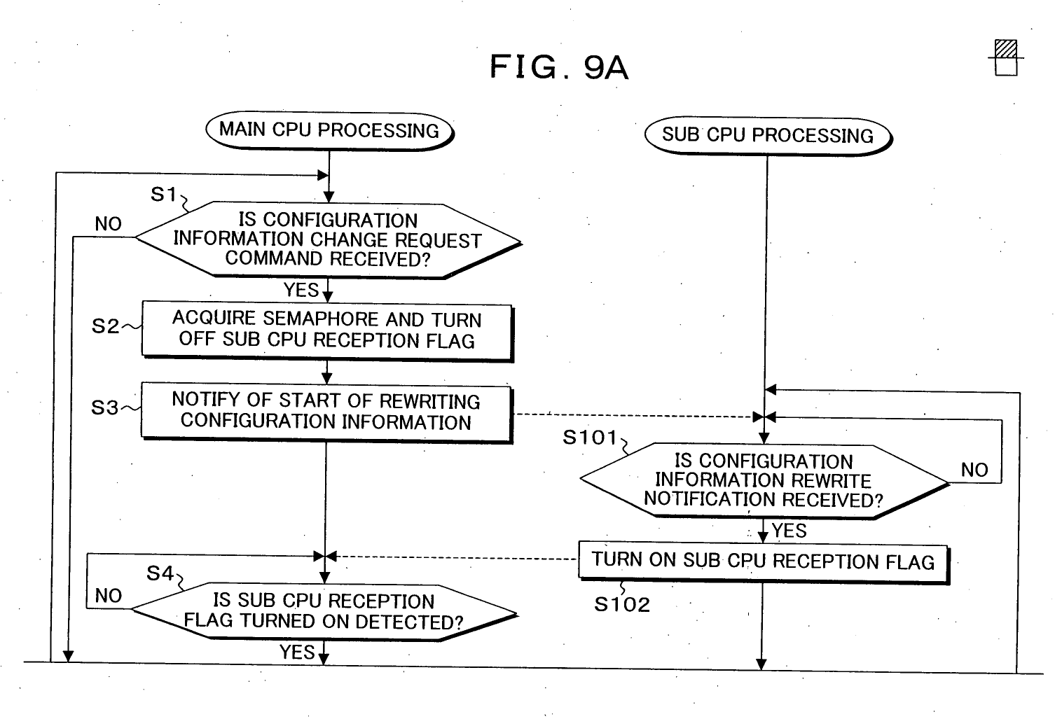

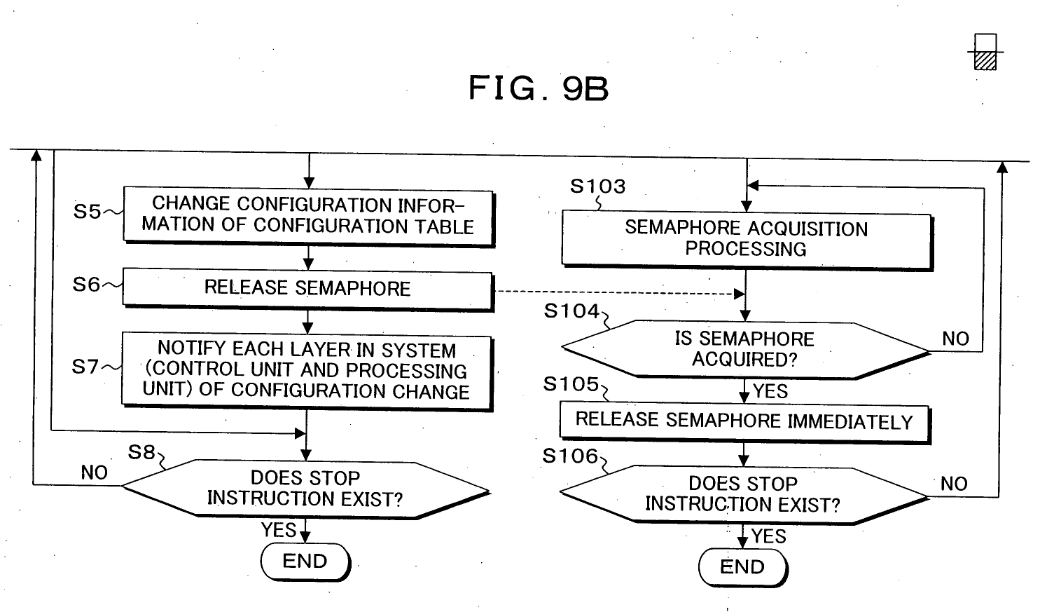

FIGS. 9A and 9B are flowcharts of the control processing of the main CPU and the sub CPU according to the third embodiment of FIGS. 8A and 8B. In FIGS. 9A and 9B, the main CPU receives the configuration information change request command in step S1, acquires the semaphore flag 106 and turns off the sub CPU reception flag 80 in step S2 and then, in step S3, notifies the sub CPU 24 of the start of the rewrite of the configuration information. In step S101, when receiving the configuration information rewrite notification from the main CPU, the sub CPU activates the maintenance agent and turns on the sub CPU reception flag 80 in step S102. The main CPU detects that the sub CPU reception flag is turned on in step S4 and proceeds to step S5 to change the configuration information of the configuration table 48. During this time, although the maintenance agent performs the semaphore acquisition processing on the sub CPU side in step S103, since the semaphore flag is acquired on the main CPU side, the semaphore cannot be acquired and the processing of step S103 is repeated until the semaphore is acquired in step S104. Therefore, the input/output control of the sub CPU 24 is prevented from referring to the configuration table being rewritten. After the configuration information is changed on the main CPU, in step S6, the semaphore flag 106 is released. Therefore, the maintenance agent of the sub CPU can immediately acquire the semaphore flag 106, in conjunction with the release of the semaphore in the main CPU; when the acquisition of the semaphore is determined in step S104, the semaphore flag is immediately released in step S105 to terminate the execution processing of the maintenance agent; and the input/output control unit 36-2 is released from the configuration table reference inhibition status and enters into the normal execution status of the input/output control unit 36-2. After releasing the semaphore in step S6, the main CPU notifies each layer in the system of the changed configuration information in step S7. The main CPU and the sub CPU repeat the processing from steps S1, S101 until a stop instruction is determined in steps S8, S106. In the table reference inhibition by prohibiting the execution of the input/output control in conjunction with the semaphore acquisition processing of the maintenance agent of the sub CPU at the time of rewriting the configuration table utilizing the acquisition of the semaphore of FIGS. 8A and 8B, the process can be easily achieved for inhibiting the reference to the configuration table being rewritten, by utilizing the semaphore function provided from OS.

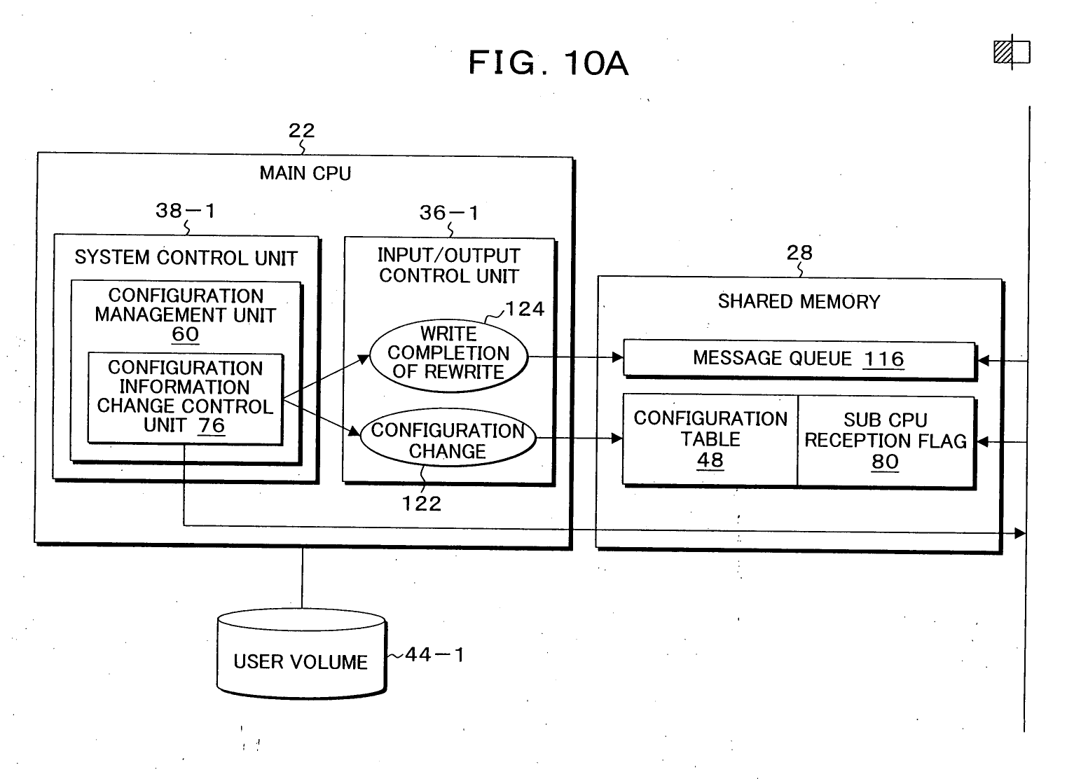

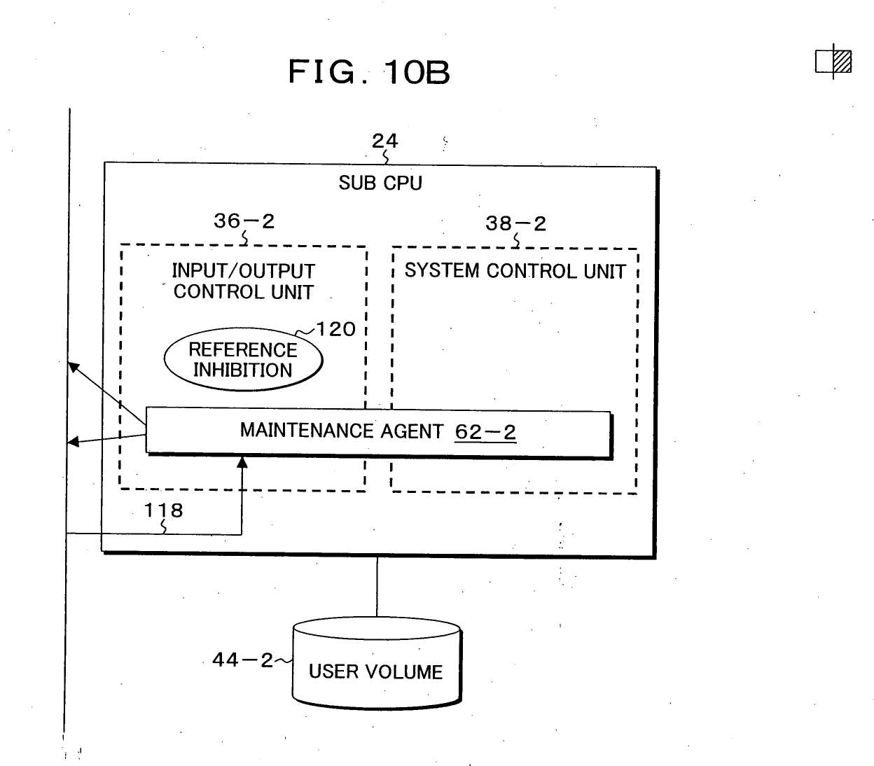

FIGS. 10A and 10B are explanatory views of a fourth embodiment of the present invention and the fourth embodiment is characterized by that the table reference of the input/output control on the sub CPU is inhibited by utilizing message queue polling processing of the maintenance agent when the main CPU changes the configuration table. In FIGS. 10A and 10B, the system control unit 38-1 of the main CPU 24 is provided with the configuration management unit 60, and the configuration information change control unit 76 is provided therein. When receiving the configuration information change instruction, the configuration information change control unit 76 of the fifth embodiment turns off the sub CPU reception flag 80 and issues a configuration information rewrite start notification 118 to the sub CPU 24. When receiving the configuration information rewrite start notification 118, the sub CPU 24 activates the maintenance agent 62-2. The maintenance agent 62-2 turns on the sub CPU reception flag 80 of the shared memory 28, makes an acknowledgement for the notification to the main CPU 22 and then starts polling processing for detecting that a rewrite completion message from the main CPU 22 is written into a message queue 116 provided on the shared memory 28. Therefore, when the main CPU 22 is rewriting the configuration table 48, since the maintenance agent 62-2 having the higher priority of the execution task is operated in the sub CPU 24 and the task of the input/output control unit 36-2 having the lower priority is not operated, the table reference can be inhibited. When terminating the processing for the configuration change 122 of the configuration table 48, the configuration information change control unit 76 writes the completion of the rewrite 124 into a message queue 116. The completion of the rewrite written into the message queue 116 is detected by the maintenance agent 62-2, and the maintenance agent 62-2 terminates the readout processing for the message queue 116 and enables the input/output control unit 36-2 to execute tasks.

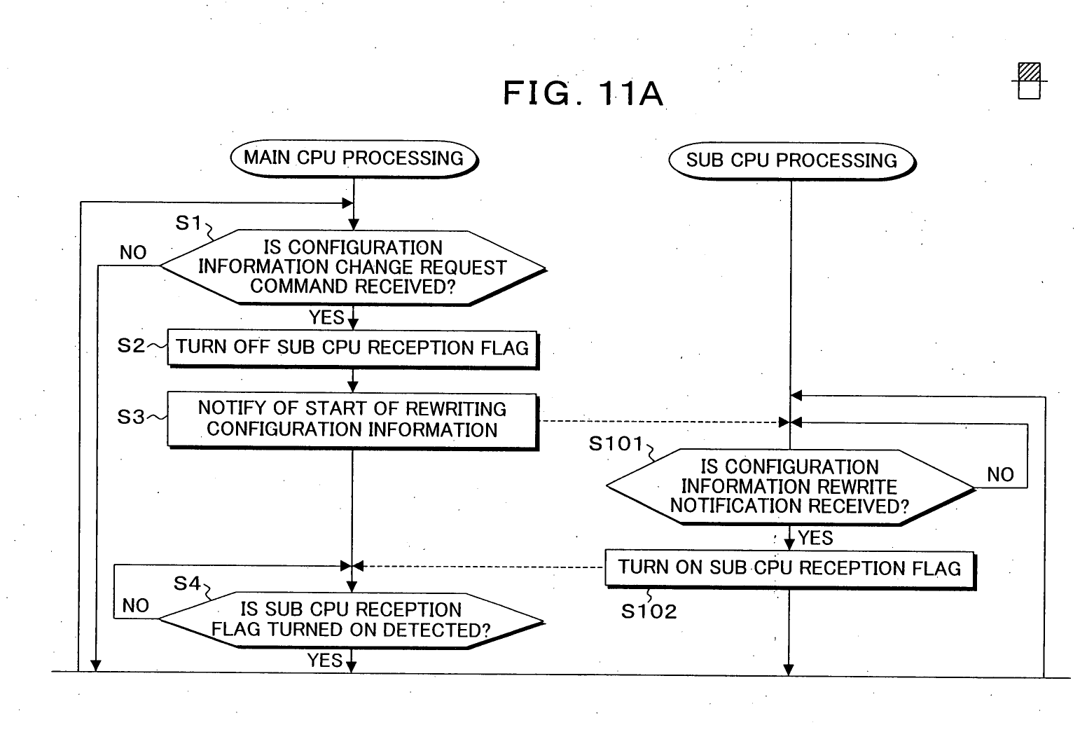

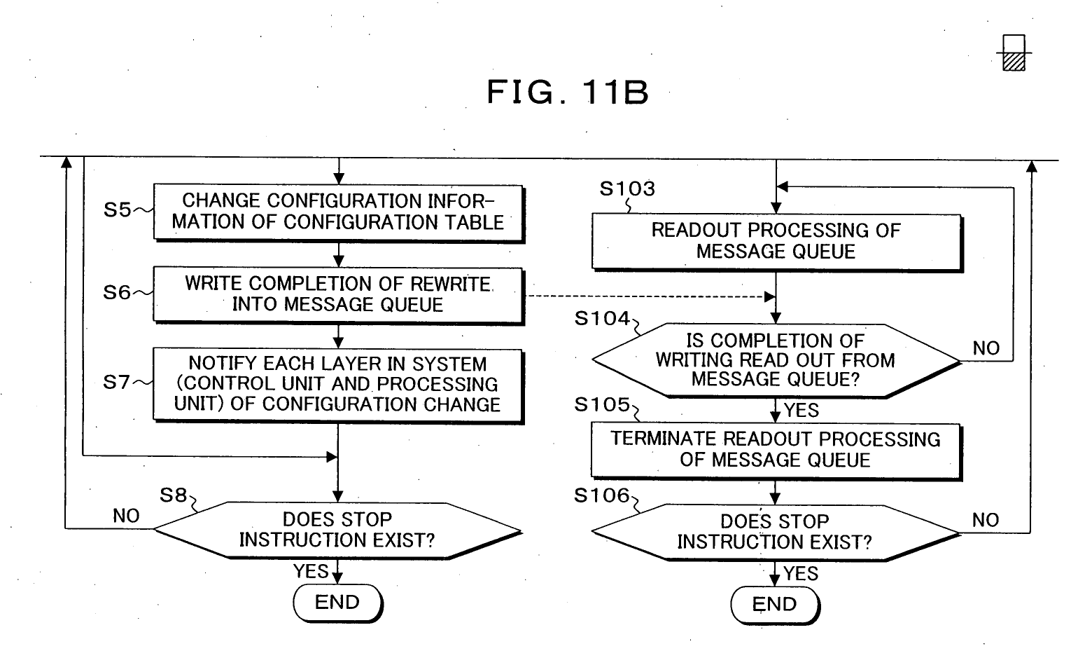

FIGS. 11A and 11B are flowcharts of the control processing of the main CPU and the sub CPU according to the fourth embodiment of FIGS. 10A and 10B. In FIGS. 11A and 11B, when receiving the configuration information change request command in step S1, the main CPU turns off the sub CPU reception flag 80 in step S2 and notifies the sub CPU 24 of the start of the rewrite of the configuration information in step S3. When determining that the configuration information rewrite notification is received from the main CPU in step S101, the sub CPU activates the maintenance agent 62-2 and turns on the sub CPU reception flag 80 in step S102 to send back the acknowledgement for the notification. The main CPU detects that the sub CPU reception flag is turned on in step S4 and changes the configuration information of the configuration table in step S5. At this point, in the sub CPU, the maintenance agent 62-2 repeatedly executes the readout processing of the message queue 116 in step S103 until the completion of the write is read out in step S104, and since the input/output control unit 36-2 with the lower priority is not operated because of the execution processing of the maintenance agent 62-2, the reference to the configuration table can be inhibited during the rewrite. After the main CPU completes the change of the configuration information, the completion of the write is written into the message queue 116 in step S6. The completion of the write written into the message queue 116 is read out in step S103 and determined in step S104, and in step S105, the maintenance agent 62-2 terminates the readout processing of the message queue 116 to enable the input/output control unit 36-2 to execute processing. On the other hand, after writing the completion of the rewrite into the message queue 116 in step S6, the main CPU notifies each layer in the system of the configuration change. Both the main CPU and the sub CPU repeat the processing from steps S1, S101 until a stop instruction exists in steps S8, S106.

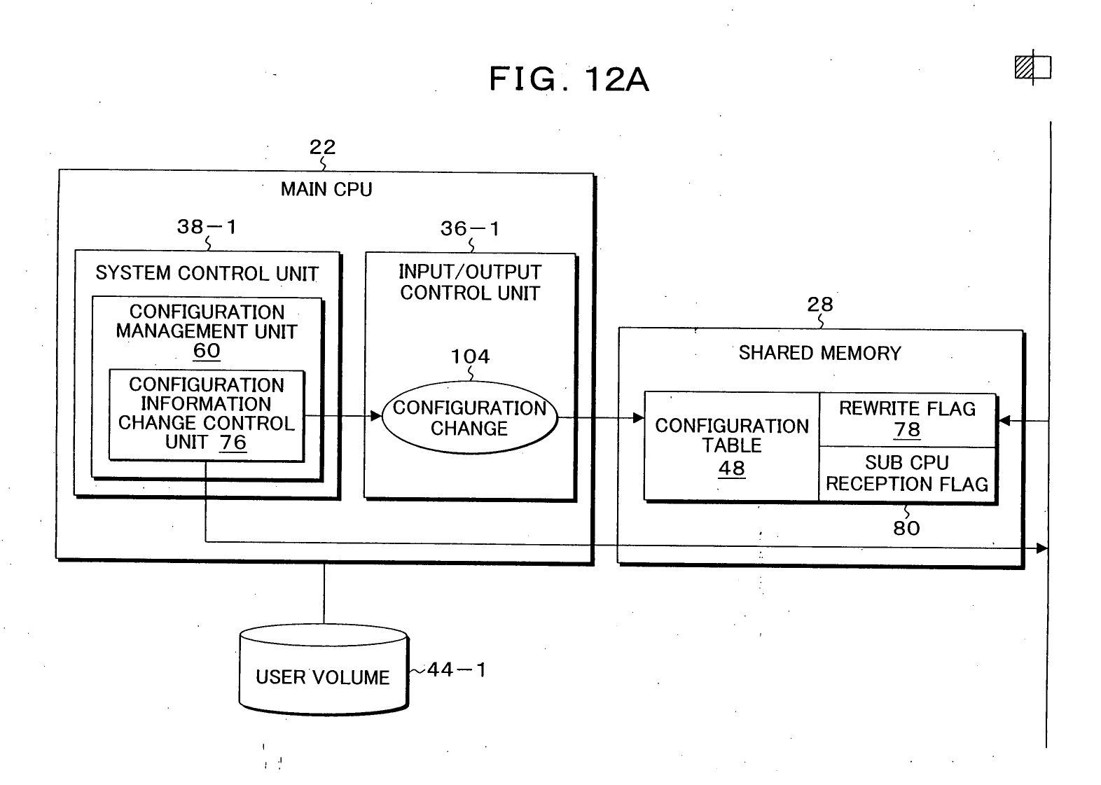

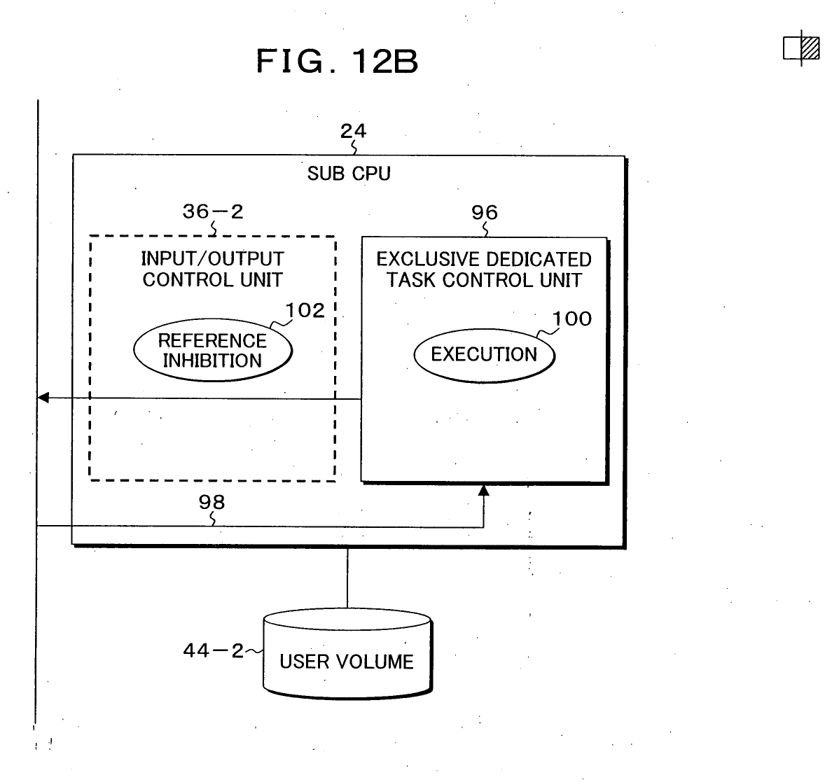

FIGS. 12A and 12B are explanatory views of a fifth embodiment of the present invention and the fifth embodiment is characterized by that the table reference of the input/output control is inhibited by forcing the sub CPU 24 to execute an exclusive dedicated task having a priority of an execution task higher than the input/output control when the main CPU 22 rewrites the configuration table 48. In FIGS. 12A and 12B, the configuration information change control unit 76 is provided in the configuration management unit 60 of the system control unit 38-1 of the main CPU 22. When receiving the configuration information change instruction, the configuration information change control unit 76 issues a configuration information rewrite start notification 110 to the sub CPU 24 and activates an exclusive dedicated task control unit 96 to be in an execution 100 status. Since the exclusive dedicated task control unit 96 is a task having the priority of the execution task higher than the input/output control unit 36-2, the task of the input/output control unit 36-2 is not executed because of the execution 100 of the exclusive dedicated task control unit 96, and the status of the configuration table 48 reference inhibition 102 can be achieved. Specifically, when the configuration information change control unit 76 receives the configuration information change instruction, the write flag 78 of the shared memory 28 is turned on; the sub CPU reception flag 80 is turned off; and then the configuration rewrite start notification 98 is issued to the sub CPU to activate the exclusive dedicated task control unit 96. The activated exclusive dedicated task control unit 96 turns on the sub CPU reception flag 80 of the shared memory 28, notifies the main CPU 22 of the acknowledgement for the notification and then starts polling processing for monitoring that the write flag 78 is turned on. After the configuration information change control unit 76 confirms that the exclusive dedicated task control unit 96 is put into the execution status on the sub CPU 24 side by turning on the sub CPU reception flag 80 of the shared memory 28 and that the reference of the input/output control unit 36-1 is inhibited, the configuration information change control unit 76 executes the configuration change 104 to rewrite the configuration table 48. When the rewrite of the configuration table 48 is completed, the write flag 78 is turned off; turning off of the write flag 78 is detected on the sub CPU side 24; and the processing of the exclusive dedicated task control unit 96 is terminated to enable the input/output control unit 36-1 to execute the task.

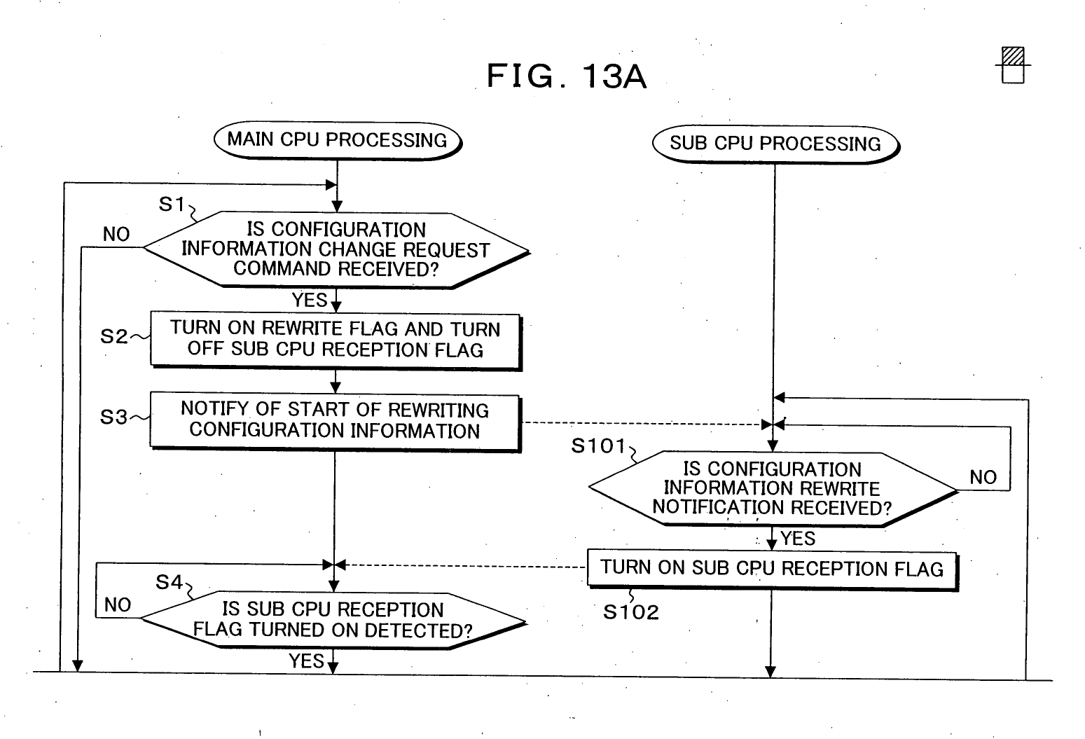

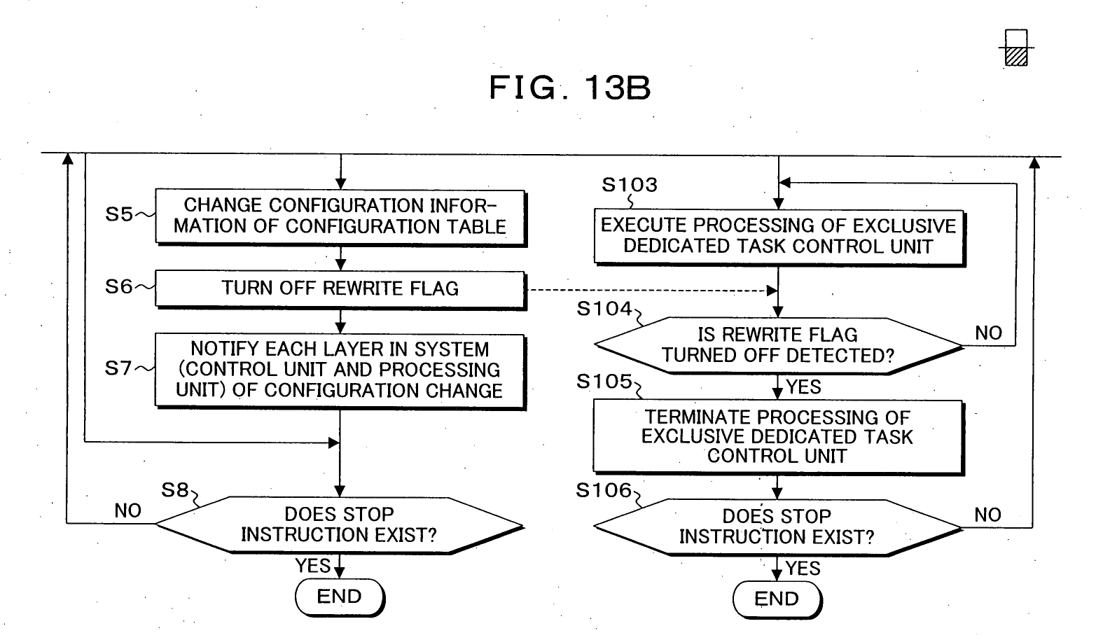

FIGS. 13A and 13B are flowcharts of the control processing of the main CPU and the sub CPU according to the fifth embodiment of FIGS. 12A and 12B. In FIGS. 13A and 13B, when receiving the configuration information change request command in step S1, the main CPU turns on the write flag 78, turns off the sub CPU flag 80 in step S2 and then notifies the sub CPU of the start of the rewrite of the configuration information in step S3. The sub CPU receives the configuration information rewrite notification from the main CPU in step S101 and turns on the sub CPU reception flag 80 in step S102. The main CPU detects that the sub CPU reception flag is turned on in step S4 and changes the configuration information of the configuration table in step S5. At this point, the sub CPU is executing the processing of the exclusive dedicated task control unit 96 in step S103 or, specifically, the polling processing for monitoring that the write flag 78 of the shared memory 28 is turned on, and the input/output control unit 36-2 with the lower priority is prevented from referring to the configuration table being rewritten. After changing the configuration information in step S5, the main CPU turns off the write flag 78 in step S6. In step S7, the changed configuration information is notified to each layer in the system. The sub CPU detects that the write flag 78 is turned off in step S104 and terminates the processing of the exclusive dedicated task control unit 96 in step S105 to enable the input/output control unit 36-2 with the lower task execution priority to be executed.

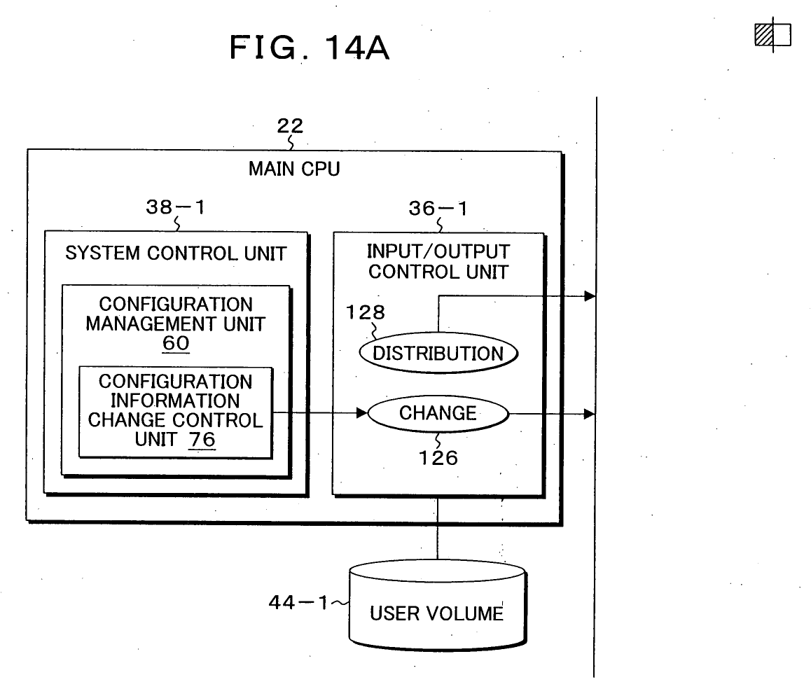

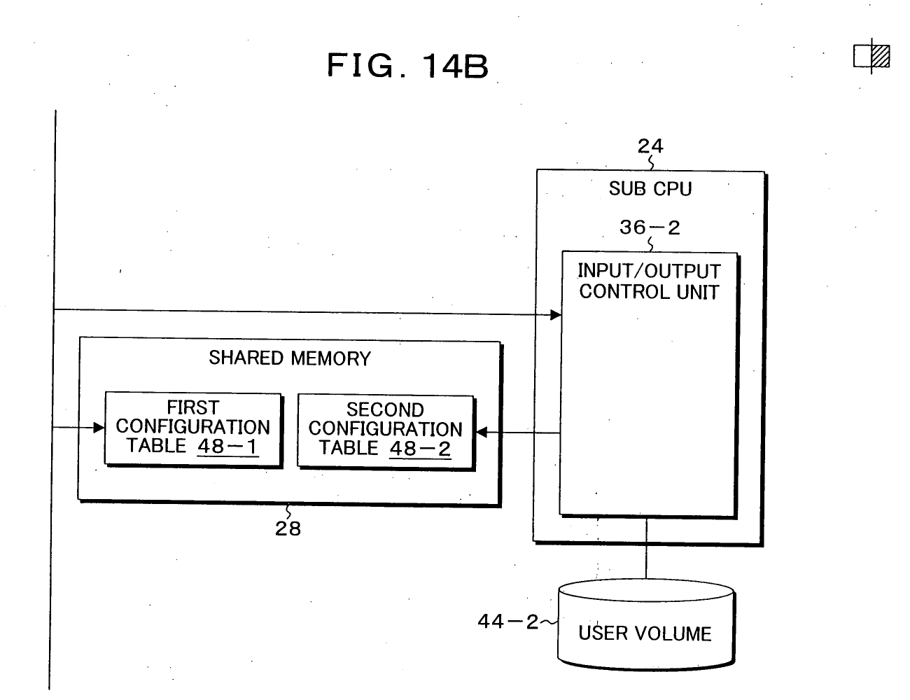

FIGS. 14A and 14B are explanatory views of a sixth embodiment of the present invention and the sixth embodiment is characterized by that a dedicated configuration table is allocated to the shared memory for each of the main CPU and the sub CPU. In FIGS. 14A and 14B, the shared memory 28 is provided with a first configuration table 48-1 used by the main CPU 22 and a second configuration table 48-2 used by the sub CPU 24 individually. The system control unit 38-1 of the main CPU 22 is provided with the configuration management unit 60, and the configuration information change control unit 76 is provided therein. When receiving the configuration information change instruction, the configuration information change control unit 76 executes the change 126 of the configuration information of the first configuration table 48-1 and performs distribution 128 of the changed configuration information to the sub CPU 24. When receiving the distribution of the changed configuration information from the main CPU 22, the sub CPU 24 performs the rewrite of the configuration information by writing the changed configuration information into the second configuration table 48-2. While the main CPU 22 is rewriting the first configuration table 48-1, since the input/output control unit 36-2 of the sub CPU 24 refers to the own dedicated second configuration table 48-2 which is provided separately, malfunctions can be prevented from occurring due to the reference to the configuration information being rewritten. This is the same as the case when the sub CPU 24 rewrites the second configuration table 48-2 in response to the distribution of the changed configuration information from the main CPU 22.

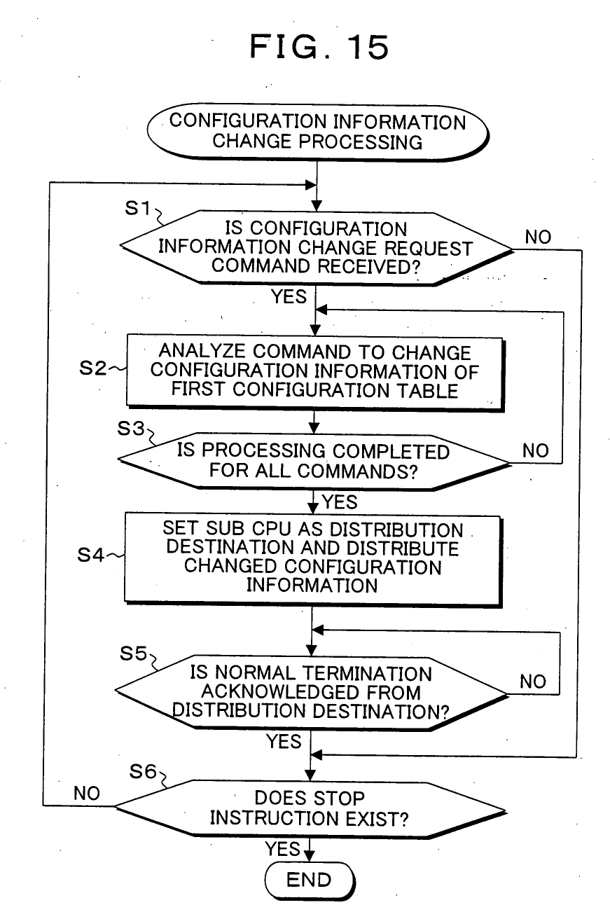

FIG. 15 is a flowchart of the configuration information change processing on the man CPU side according to the sixth embodiment of FIGS. 14A and 14B. In FIG. 15, when determining that the configuration information change request command is received in step S1, the main CPU 22 analyzes the command and changes the configuration information of the first configuration in step S2. When it is determined that the processing is completed for all the commands in step S3, the sub CPU 24 is set as a distribution destination in step S4 to execute the change of the configuration information of the second configuration table 48-2 on the sub CPU 24 side. Then, after waiting for a normal termination acknowledgement from the sub CPU 24, i.e., the distribution destination in step S5, the series of the processing is terminated. The processing from step S1 to step S5 is repeated until a stop instruction is determined in step S6. In the sixth embodiment of FIGS. 14A and 14B, by providing the dedicated configuration tables 48-1, 48-2 for the main CPU 22 and the sub CPU 24 on the shared memory 28, although the more memory area is required for the tables, since each of the main CPU 22 and the sub CPU 24 has the configuration table independently and changes the configuration information, it is not needed to consider the exclusive control due to the sharing of the configuration table and this makes the control processing of the main CPU 22 and the sub CPU 24 easier.

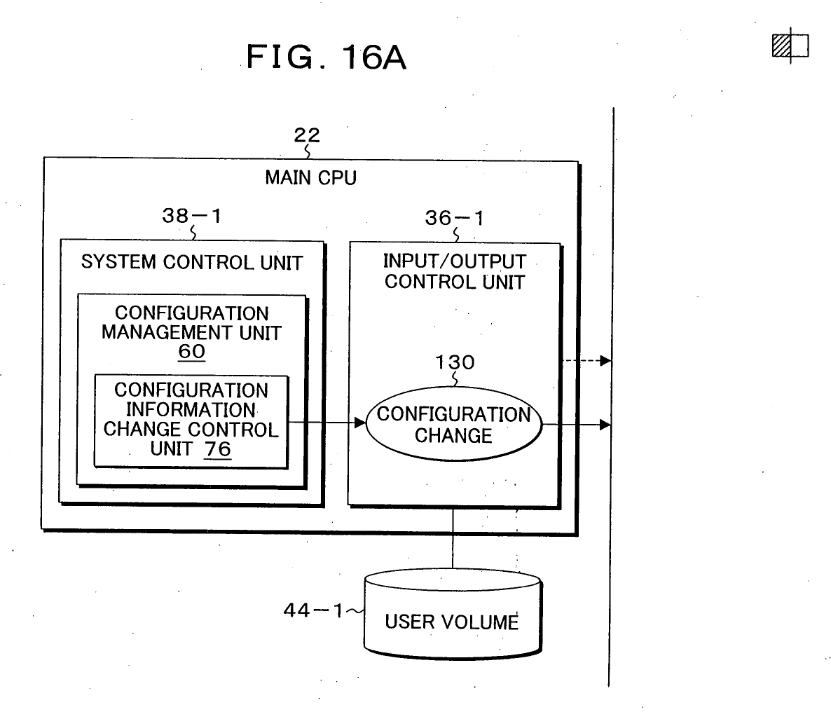

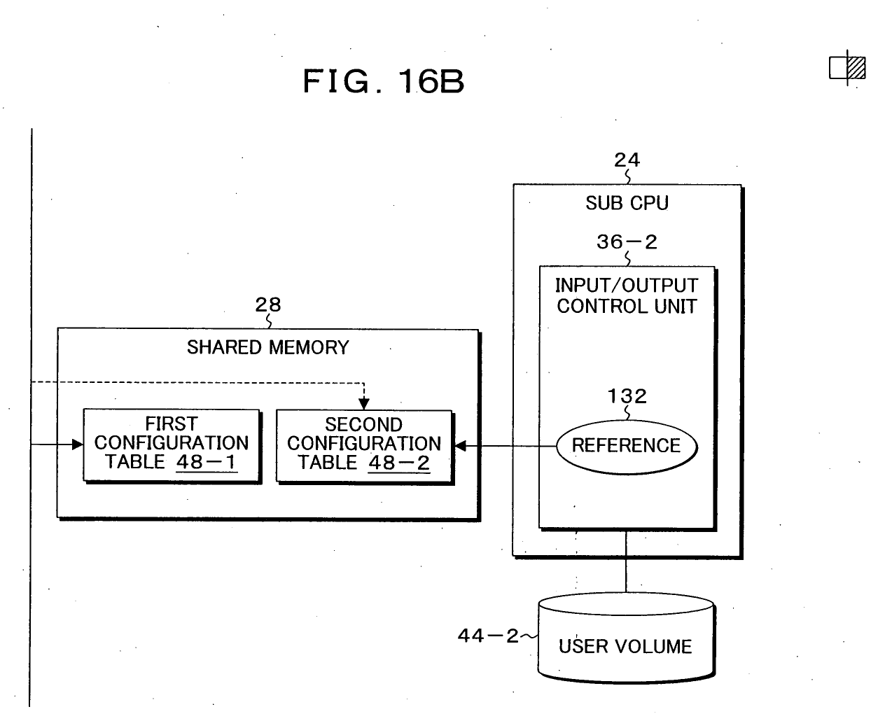

FIGS. 16A and 16B are explanatory views of a seventh embodiment of the present invention and the seventh embodiment is characterized by that the reference during the table rewrite is inhibited by mirroring the configuration table to provide two configuration tables deployed on the shared memory. In FIGS. 16A and 16B, the shared memory 28 is provided with a first configuration table 48-1 and a second configuration table 48-2 where the configuration information is changed by the configuration information change control unit 76 of the main CPU 22. The first configuration table 48-1 and the second configuration table 48-2 are mirrored by storing the same configuration information. When receiving the configuration information change instruction, the configuration information change control unit 76 of the main CPU 22 enables the reference of the input/output control by setting a reference pointer to the second configuration table 48-2 which is forced to be in an active status and executes processing of the configuration change 130 for rewriting the configuration information of the first configuration table 48-1 which is the inactive side having no reference pointer. After the first configuration table 48-1 is rewritten, the reference pointer is transferred from the second configuration table 48-2 to the first configuration table 48-1 which is forced to be in the active status and executes the configuration change 130 for changing the configuration information of the second configuration table 48-2 which is the inactive side where the reference pointer is removed. Therefore, during the rewrite, the first configuration table 48-1 and the second configuration table 48-2 are put into the inactive status by removing the reference pointer, and since the reference 132 of the input/output control from the sub CPU 24 is performed to the other configuration table to which the reference pointer is set, the malfunction can certainly be prevented from occurring due to the reference to the configuration table being rewritten.

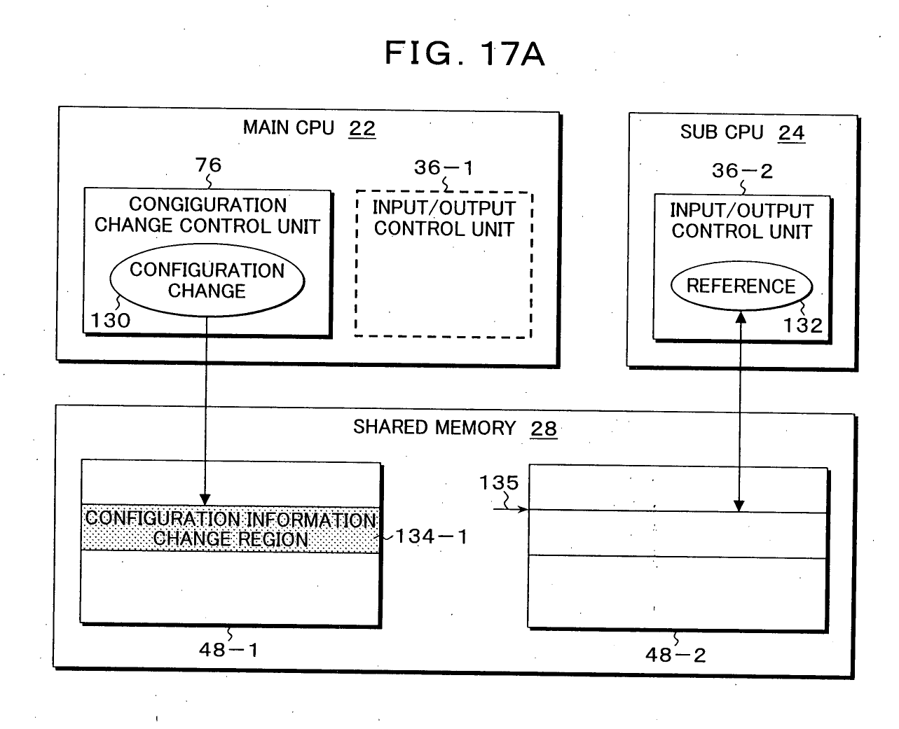

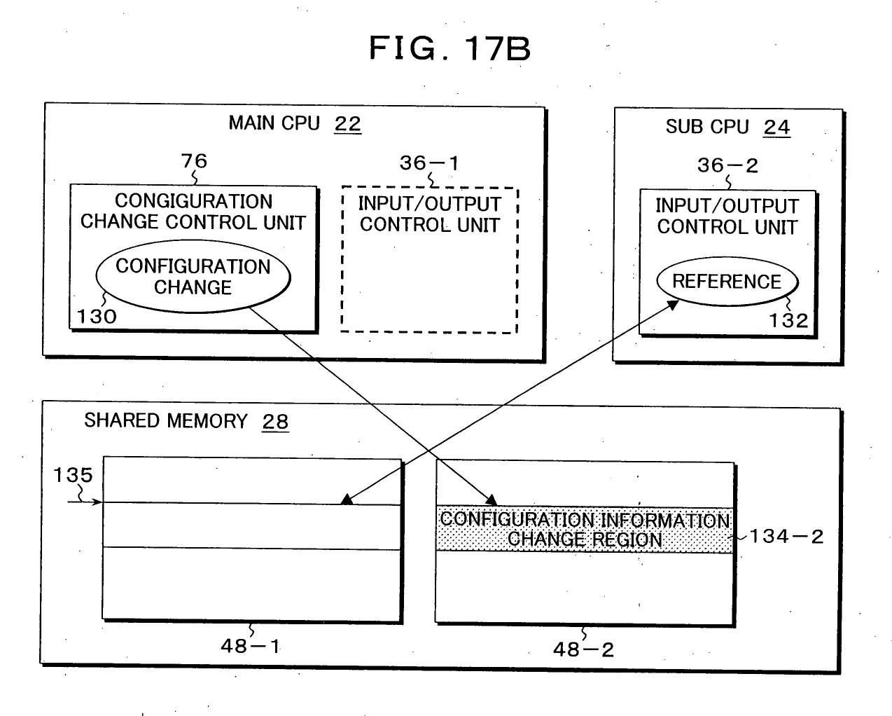

FIGS. 17A and 17B are explanatory views of the processing for referring to one configuration table while the other configuration table is rewritten, according to the seventh embodiment of FIGS. 16A and 16B. In FIG. 17A, the second configuration table 48-2 provided on the shared memory 28 is put into the active status by setting the reference pointer 135, and thereby, the input/output control unit 36-2 of the sub CPU 24 is enabled to execute the reference 132. On the other hand, for the first configuration table 48-1 which is the target of the configuration information change, since the reference pointer 135 is removed for putting into the inactive status, the reference is not performed by the input/output control, and the configuration information change control unit 76 of the main CPU 22 executes a change 130 of a configuration information change region. After the first configuration table 48-1 is rewritten, as shown in FIG. 17B, the reference pointer 135 is switched to the first configuration table 48-1 side which is put into the active status; the second configuration table 48-2 is put into the inactive status by removing the reference pointer; and the configuration information change control unit 76 of the main CPU 22 executes a change 130 of a configuration information change region 134 in this inactive status.

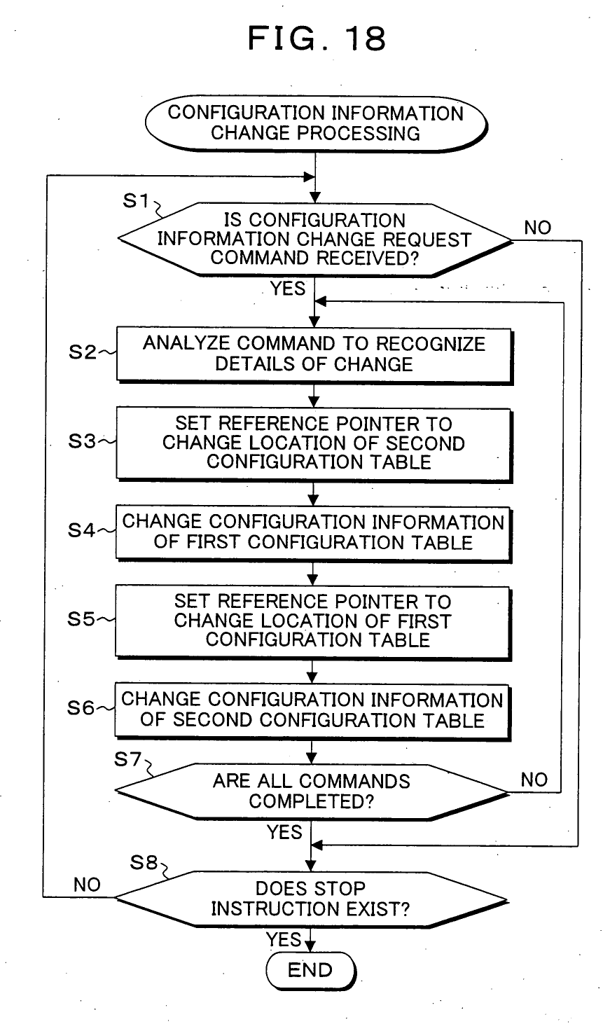

FIG. 18 is a flowchart of the configuration information change processing according to the seventh embodiment of FIGS. 16A and 16B. In FIG. 18, when the configuration information change control unit 76 provided on the main CPU 22 determines that the configuration information reception command is received in step S1, the command is analyzed and the details of the change is recognized in step S2; the reference of the input/output control is enabled by setting the reference pointer 135 to the second configuration table 48-2 which is put into the active status in step S3; and then, in step S4, the configuration information is changed in the first configuration table 48-1 which is put into the inactive status by removing the reference pointer. Then, in step S5, the reference of the input/output control is enabled by setting the reference pointer to the first configuration table 48-1 which is put into the active status, and in step S6, the configuration information is changed in the second configuration table 48-2 which is put into the inactive status by removing the reference pointer. The processing from step S2 is repeated until all the commands are completed in step S7. Also, the processing from step S1 is repeated until the stop instruction is determined in step S8. In the seventh embodiment of FIGS. 16A and 16B, by providing the two mirrored configuration tables on the shared memory 28, by switching the reference pointer to put one configuration table into the active status for the reference and put the other into the inactive status and by changing the configuration information on the inactive status side, malfunctions can be certainly prevented from occurring due to the reference to the configuration information being rewritten. As compared to the case that the dedicated configuration table is individually provided on the main CPU 22 and the sub CPU 24 as shown in FIGS. 14A and 14B, the processing becomes easier since only the processing on the main CPU 22 side can achieve the configuration information change in two (2) tables because of mirroring.

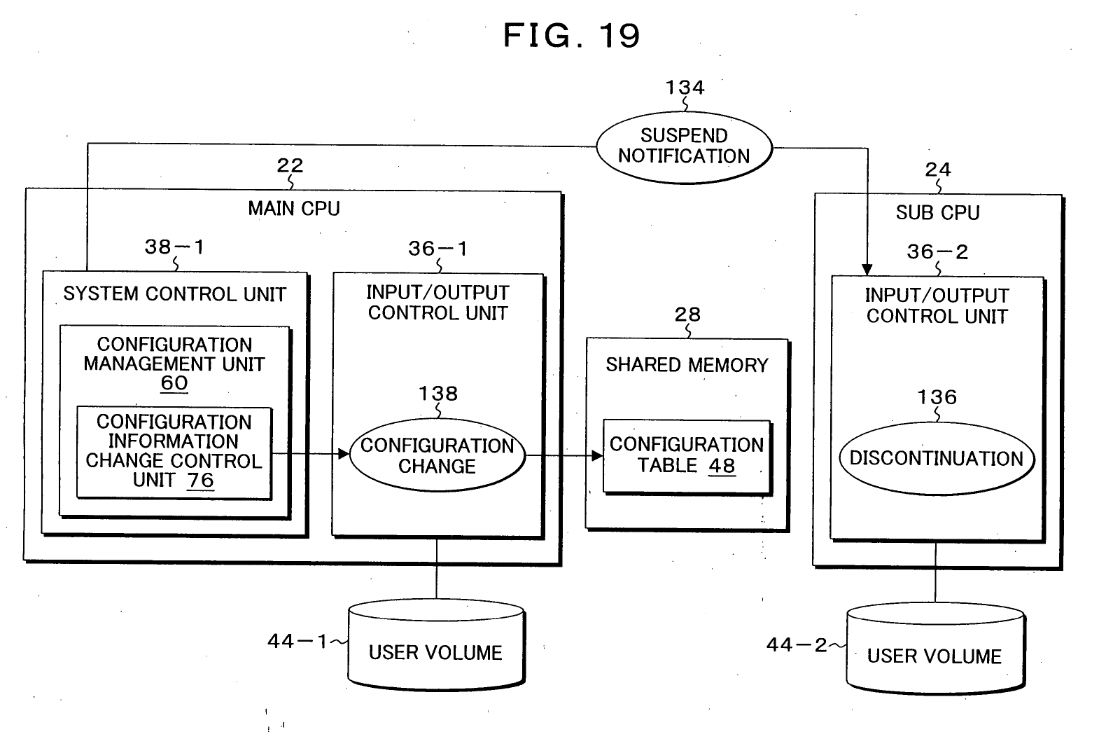

FIG. 19 is an explanatory view of a eighth embodiment of the present invention and the eighth embodiment is characterized by that the reference during the table rewrite is inhibited by notifying the sub CPU of suspend (interruption) to discontinue acceptance of input/output requests when the main CPU changes the configuration table. In FIG. 19, the system control unit 38-1 of the main CPU 22 is provided with the configuration management unit 60, and the configuration information change control unit 76 is provided therein. When receiving the configuration information change instruction, the configuration information change control unit 76 issues a suspend notification 134 to the sub CPU 24. When receiving the suspend notification from the main CPU 22, the sub CPU 24 completes input/output requests that have been already accepted from the sever which is the higher-level apparatus and will not accept new input/output requests in the input/output control unit 36-2. Specifically, an acceptance inhibition status is set to an input/output port from the server to the input/output control unit 36-2. In this way, the input/output control unit 36-2 is in a state of discontinuation 136. Then, the configuration information change control unit 76 of the main CPU 22 executes the configuration change 138 for rewriting the configuration information of the configuration table 48 of the shared memory 28. After the configuration table 48 is rewritten, the configuration information change control unit 76 performs a resume notification (restart notification) to the sub CPU 24. When receiving the resume notification, the sub CPU 24 releases the discontinuation state to enable the input/output request from the host.

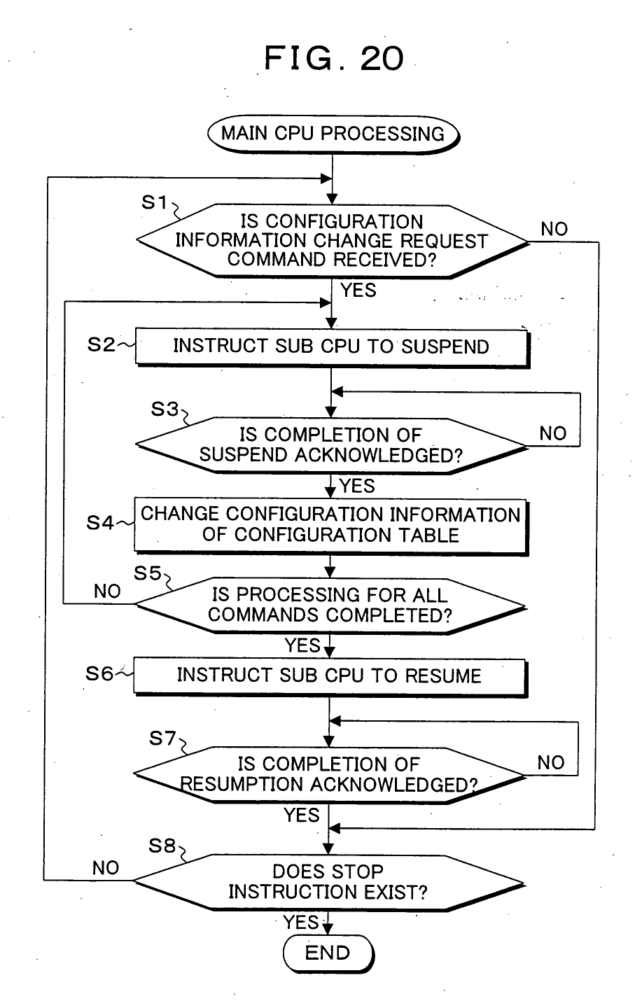

FIG. 20 is a flowchart of the main CPU processing according to the eighth embodiment of FIG. 19. In FIG. 20, when determining that the configuration information change request command is received in step S1, the main CPU 22 instructs suspend to the sub CPU 24 in step S2. Then, in step S3, when it is determined that the completion of suspend is acknowledged in step S3, the configuration of the configuration table is changed. Then, when it is determined that the processing for all the commands is completed in step S5, the resume is notified to the sub CPU to request restart of processing. Then, when it is determined that the completion of restart is acknowledged in step S7, the series of the processing is terminated. The processing from step S1 to S7 is repeated until the stop instruction exists in steps S8.

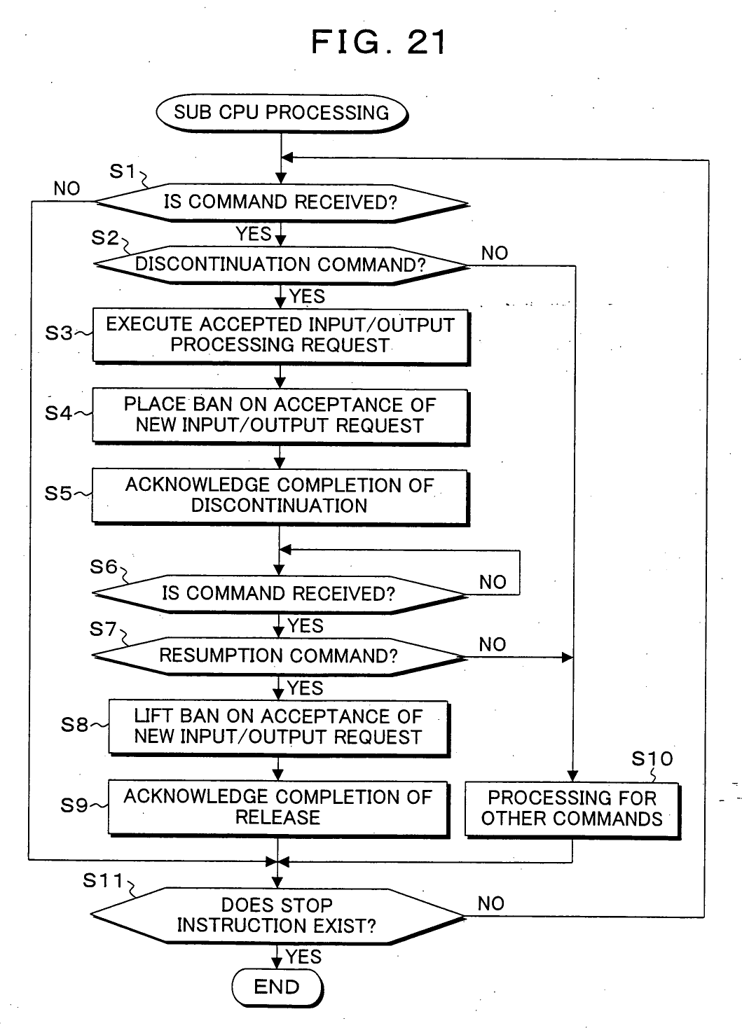

FIG. 21 is a flowchart of the sub CPU processing according to the eighth embodiment of FIG. 19. In FIG. 21, the sub CPU 24 checks whether the command is received or not in step S1, and when determining that the received command is the discontinuation command in step S2, the sub CPU 24 executes the input/output requests that have been accepted in step S3 and places ban on acceptance of new input/output requests in step S4. Then, in step S5, the completion of discontinuation is acknowledged to the main CPU 22. Then, it is determined whether a command is received or not in step S6, and when it is determined the a command is received and it is determined that the command is a restart command in step S7, the ban on the acceptance of new input/output requests is lifted in step S8 and the completion of the lifting of the ban is acknowledged to the main CPU in step S9. If it is determined in step S2 or step S7 that the command is not the target command of the determination, the procedure proceeds to step S10 to perform processing for other commands. The processing from step S1 is repeated until the stop instruction exists in steps S11. In the eighth embodiment of FIG. 19, the reference of the input/output control unit to the configuration table being rewritten can be inhibited by utilizing the command functions for the discontinuation with the suspend notification and the restart with the resume notification to the input/output control units 36-1, 36-2 provided on the system control unit 38-1 of the main CPU 22. For the discontinuation of the sub CPU 24 with the suspend notification, since new input/output requests will not be accepted after the processing is completed for input/output requests that have been received at that point, some processing time is required between the issuance of the suspend notification to the actual discontinuation, and the rewrite of the configuration table must wait during this processing time. Contrary to this, in the first embodiment of FIGS. 4A and 4B, the second embodiment of FIGS. 6A and 6B, the third embodiment of FIGS. 8A and 8B, the fourth embodiment of FIGS. 10A and 10B and the fifth embodiment of FIGS. 12A and 12B, since the functions can be in a near-interrupting manner by forcing the sub CPU 24 side to perform the operation for inhibiting the reference of the input/output control to the configuration table being rewritten with the task-level processing, the processing performance is increased as compared to the eighth embodiment of FIG. 19. On the other hand, in the eighth embodiment, since the reference of the input/output control to the configuration table being rewritten can be inhibited by utilizing existing commands of suspend and resume which are possessed by the system control unit in advance for the input/output control unit, the control function of the configuration information change control unit 76 can be advantageously simplified.

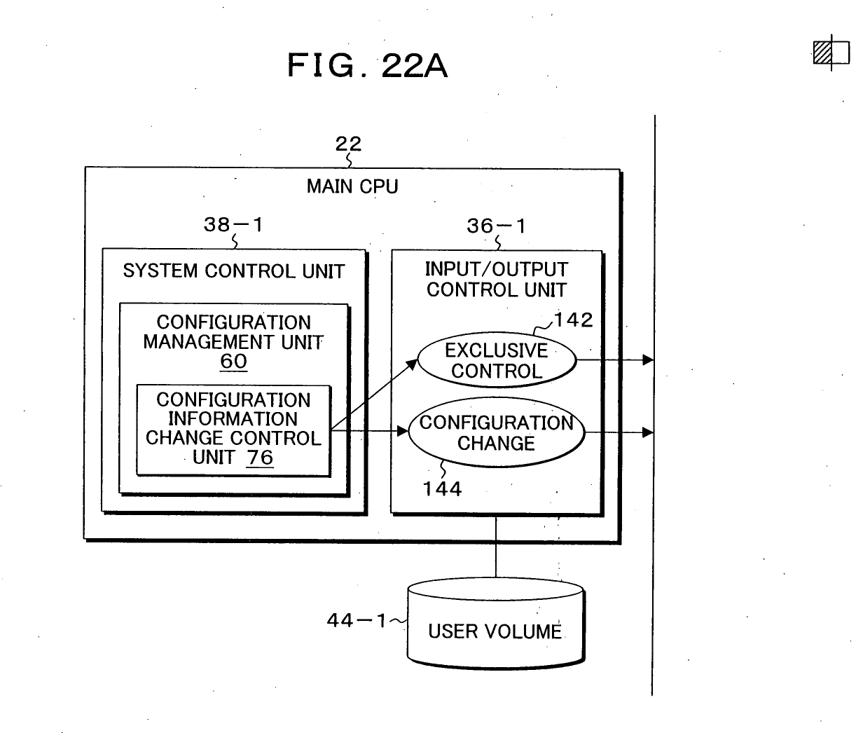

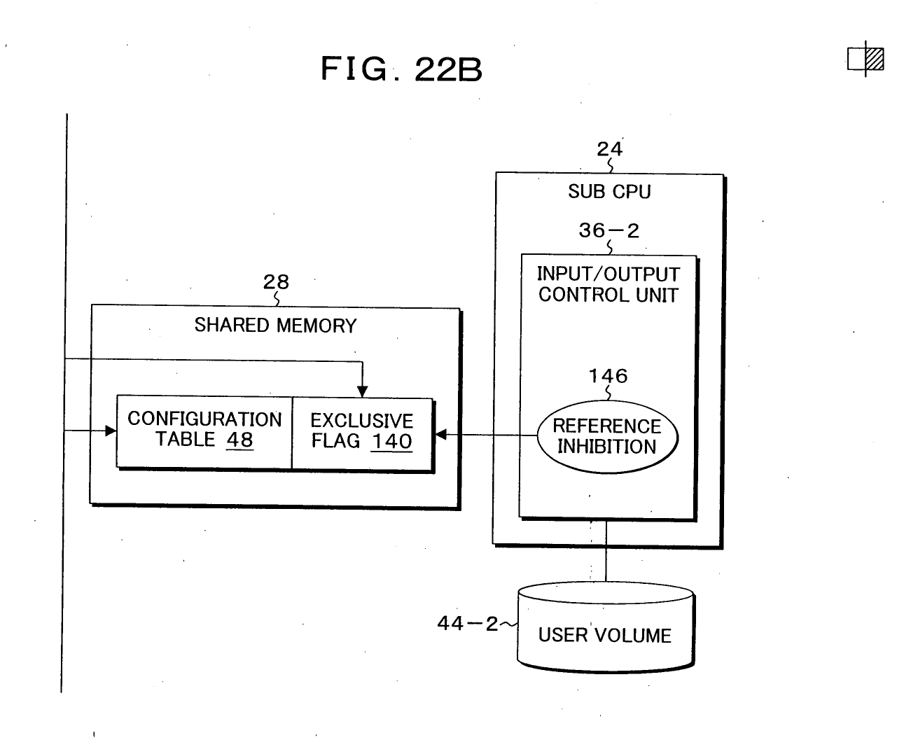

FIGS. 22A and 22B are explanatory views of a ninth embodiment of the present invention and the ninth embodiment is characterized by that the table reference of the input/output control of the sub CPU is inhibited by acquiring an exclusive lock of the configuration table before the main CPU rewrites the configuration table. In FIGS. 22A and 22B, the system control unit 38-1 of the main CPU 22 has the configuration management unit 60, and the configuration management unit 60 is provided with the configuration information change control unit 76. When receiving the configuration information change instruction, the configuration information change control unit 76 of the ninth embodiment performs exclusive control 142 for acquiring the exclusive lock by turning on an exclusive flag 140 provided in the configuration table 48 and then executes the configuration change 144 of the configuration table 48. Although, if the input/output control unit 36-2 of the sub CPU 24 refers to the configuration table 48 when the main CPU 22 is rewriting the configuration table, the input/output control unit 36-2 tries to acquire the exclusive flag 140, since the exclusive flag 140 is already acquired by CPU 22 and is in a lock status, the input/output control unit 36-2 cannot acquire the exclusive flag 140 and is put into a state of reference inhibition 146, and the reference to the configuration table 48 has to wait until the exclusive flag 140 is turned off and unlocked by the completion of the configuration change.

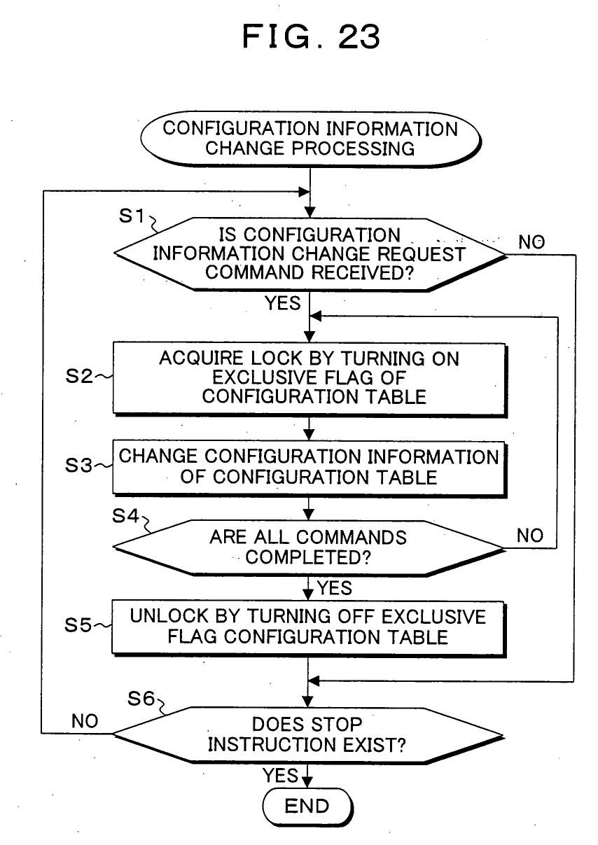

FIG. 23 is a flowchart of the configuration information change processing of the main CPU according to the ninth embodiment. In FIG. 23, when receiving the configuration information change request command in step S1, the main CPU acquires the exclusive flag 140 of the configuration table 48 in step S2 and changes the configuration information in step S3. After repeating the processing until all the commands are completed, the main CPU turns off and unlocks the exclusive flag 140 of the configuration table 48 to enable the input/output control unit of the sub CPU to acquire the exclusive lock and to allow for the reference to the configuration table 48. The processing is repeated until the stop instruction exists in step S6. The ninth embodiment of FIGS. 22A and 22B can certainly inhibit the input/output control of the sub CPU to refer to the configuration table being rewritten and prevent malfunctions by waiting for turning off and unlocking of the exclusive flag at the time of the reference in order to inhibit the reference to the configuration table being rewritten. Also, the present invention provides a computer constituting the RAID apparatus, specifically a program executed by the main CPU, and the program has contents of the flowcharts shown as the main CPU processing in FIGS. 5A and 5B, FIGS. 7A and 7B, FIGS. 9A and 9B, FIGS. 11A and 11B, FIGS. 13A and 13B, FIG. 15, FIG. 18, FIG. 20 and FIG. 23. The present invention encompasses any modifications without impairing the object and benefits thereof and is not intended to be limited by numerical values indicated in the above embodiment.

What is claimed is:

1. A storage apparatus comprising:
a first processing unit including, as execution targets, a first input/output control unit which refers to configuration information to execute input/output processing of a volume and a configuration management unit which manages configuration information;
a second processing unit including, as execution targets, a second input/output control unit which refers to the configuration information to execute input/output processing of another volume and a higher-priority control unit which has an execution priority higher than the second input/output control unit; and
a shared memory which is allocated with a configuration table storing the configuration information,
wherein the storage apparatus comprises a configuration information change control unit which, when receiving a configuration information change instruction, changes configuration information of the configuration table while the second input/output control unit is inhibited from referring to the configuration table by forcing the second processing unit to execute processing of the higher-priority control unit, the configuration information change control unit allowing the second processing unit to terminate processing of the higher-priority control unit with completion of the change of the configuration information.

2. The storage apparatus of claim 1, wherein the higher-priority control unit is a system control unit managing the entire system, and
wherein when receiving the configuration information change instruction, the configuration information change control unit turns on a in-rewrite flag of the configuration table, turns off a second processing unit reception flag, then notifies the second processing unit of start of rewrite of the configuration information, changes the configuration information of the configuration table when detecting that the second processing unit reception flag is turned on in accompaniment with execution of processing of the system control unit by the second processing unit, and turns off the in-rewrite flag with completion of the change of the configuration information to force the second processing unit to terminate the processing of the system control unit.

3. The storage apparatus of claim 1, wherein the higher-priority control unit is a command relay control unit relaying commands between a system control unit managing the entire system and the second input/output control unit, and
wherein when receiving the configuration information change instruction, the configuration information change control unit turns on a in-rewrite flag of the configuration table, turns off a second processing unit reception flag, then notifies the second processing unit of start of rewrite of the configuration information, changes the configuration information of the configuration table when detecting that the second processing unit reception flag is turned on in accompaniment with execution of processing of the command relay control unit by the second processing unit, and turns off the in-rewrite flag with completion of the change of the configuration information to force the second processing unit to terminate the processing of the command relay control unit.

4. The storage apparatus of claim 1, wherein the higher-priority control unit is a command relay control unit relaying commands between a system control unit managing the entire system and the second input/output control unit, and
wherein when receiving the configuration information change instruction, the configuration information change control unit acquires a semaphore, then changes the configuration information of the configuration table during the reference of the second input/output processing unit to the configuration table is inhibited by forcing the command relay control unit to execute semaphore-acquisition processing with the second processing unit, releases the semaphore with completion of the change of the configuration information to allow the command relay control unit of the second processing unit to acquire the semaphore, and then forcing the semaphore-acquisition processing to be terminated.

5. The storage apparatus of claim 1, wherein the higher-priority control unit is a command relay control unit relaying commands between a system control unit managing the entire system and the second input/output control unit, and
wherein when receiving the configuration information change instruction, the configuration information change control unit changes the configuration information of the configuration table during the reference of the second input/output processing unit to the configuration table is inhibited by forcing the command relay control unit to execute the relay queue readout processing with the second processing unit and forces the command relay control unit of the second processing unit to terminate the relay queue readout processing by writing completion of the change of the configuration information into the relay queue.

6. The storage apparatus of claim 1, wherein the higher-priority control unit is an exclusive dedicated task control unit provided for exclusive dedicated task processing, and
wherein when receiving the configuration information change instruction, the configuration information change control unit turns on a in-rewrite flag of the configuration table, turns off a second processing unit reception flag, then notifies the second processing unit of start of rewrite of the configuration information, changes the configuration information of the configuration table when detecting that the second processing unit reception flag is turned on in accompaniment with execution of processing of the exclusive dedicated task control unit by the second processing unit, and turns off the in-rewrite flag with completion of the change of the configuration information to force the second processing unit to terminate the processing of the exclusive dedicated task control unit.

7. A configuration information management method in a storage apparatus comprising:
a first processing unit comprising, as execution targets, a first input/output control unit which refers to configuration information to execute input/output processing of a volume and a configuration management unit which manages the configuration information;
a second processing unit comprising, as execution targets, a second input/output control unit which refers to the configuration information to execute input/output processing of another volume and a higher-priority control unit which has an execution priority higher than the second input/output control unit; and
a shared memory which is allocated with a configuration table storing the configuration information, the configuration information management method comprising:
a reference inhibition step of inhibiting reference of the second input/output control unit to the configuration table by forcing the second processing unit to execute processing of the higher-priority control unit when receiving the configuration information change instruction;
a configuration information change step of changing the configuration information of the configuration table during the reference to the configuration table is inhibited; and
a reference inhibition release step of forcing the second processing unit to terminate the processing of the higher-priority control unit with completion of the change of the configuration information.

8. The configuration information management method of claim 7 wherein the higher-priority control unit is a system control unit managing the entire system,
wherein the reference inhibition step includes, upon reception of the configuration information change instruction, turning on a in-rewrite flag of the configuration table, turning off a second processing unit reception flag, and then notifying the second processing unit of start of rewrite of the configuration information, and
wherein configuration information change step includes changing configuration information of the configuration table when detecting that the second processing unit reception flag is turned on in accompaniment with execution of processing of the system control unit by the second processing unit, and
wherein the reference inhibition release step includes turning off the in-rewrite flag with completion of the change of the configuration information to force the second processing unit to terminate the processing of the system control unit.

9. The configuration information management method of claim 7, wherein the higher-priority control unit is a command relay control unit relaying commands between a system control unit managing the entire system and the second input/output control unit,
wherein upon reception of the configuration information change instruction, the reference inhibition step includes turning on a in-rewrite flag of the configuration table, turning off a second processing unit reception flag, and then notifying the second processing unit of start of rewrite of the configuration information,
wherein the configuration information change step includes changing the configuration information of the configuration table when detecting that the second processing unit reception flag is turned on in accompaniment with execution of processing of the command relay control unit by the second processing unit, and
wherein the reference inhibition release step includes turning off the in-rewrite flag with completion of the change of the configuration information to force the second processing unit to terminate the processing of the command relay control unit.

10. The configuration information management method of claim 7, wherein the higher-priority control unit is a command relay control unit relaying commands between a system control unit managing the entire system and the second input/output control unit, the method further comprising:
a reference inhibition step of, when receiving the configuration information change instruction, acquiring a semaphore and then forcing the command relay control unit of the second processing unit to execute semaphore-acquisition processing to inhibit the second input/output processing unit from referring to the configuration table;
a configuration information change step of changing the configuration information of the configuration table with the reference to the configuration table being inhibited; and
a reference inhibition release step of releasing the semaphore with completion of the change of the configuration information to allow the command relay control unit of the second processing unit to acquire the semaphore, to thereafter terminate the semaphore-acquisition processing.

11. The configuration information management method of claim 7, wherein the higher-priority control unit is a command relay control unit relaying commands between a system control unit managing the entire system and the second input/output control unit, the method comprising:
a reference inhibition step of, when receiving the configuration information change instruction, forcing the command relay control unit of the second processing unit to execute the relay queue readout processing to inhibit the second input/output processing unit from referring to the configuration table;
a configuration information change step of changing the configuration information of the configuration table with the reference to the configuration table being inhibited; and
a reference inhibition release step of writing completion of the change of the configuration information into the relay queue to allow the command relay control unit of the second processing unit to terminate the relay queue readout processing.

12. A configuration information management program operable to drive a computer constituting a first processing unit of a storage apparatus, the storage apparatus comprising:
the first processing unit including, as execution targets, a first input/output control unit which refers to configuration information to execute input/output processing of a volume and a configuration management unit which manages the configuration information;
a second processing unit including, as execution targets, a second input/output control unit which refers to the configuration information to execute input/output processing of another volume and a higher-priority control unit which has an execution priority higher than the second input/output control unit; and
a shared memory which is allocated with a configuration table storing the configuration information,
to execute:
a reference inhibition step of inhibiting reference of the second input/output control unit to the configuration table by forcing the second processing unit to execute processing of the higher-priority control unit when receiving the configuration information change instruction;
a configuration information change step of changing the configuration information of the configuration table during the reference to the configuration table is inhibited; and
a reference inhibition release step of forcing the second processing unit to terminate the processing of the higher-priority control unit with completion of the change of the configuration information.

13. The configuration information management program of claim 12 wherein the higher-priority control unit is a system control unit managing the entire system,
wherein the reference inhibition step includes, upon reception of the configuration information change instruction, turning on a in-rewrite flag of the configuration table, turning off a second processing unit reception flag, and then notifying the second processing unit of start of rewrite of the configuration information, and
wherein configuration information change step includes changing configuration information of the configuration table when detecting that the second processing unit reception flag is turned on in accompaniment with execution of processing of the system control unit by the second processing unit, and
wherein the reference inhibition release step includes turning off the in-rewrite flag with completion of the change of the configuration information to force the second processing unit to terminate the processing of the system control unit.

14. The configuration information management program of claim 12, wherein the higher-priority control unit is a command relay control unit relaying commands between a system control unit managing the entire system and the second input/output control unit,
wherein upon reception of the configuration information change instruction, the reference inhibition step includes turning on a in-rewrite flag of the configuration table, turning off a second processing unit reception flag, and then notifying the second processing unit of start of rewrite of the configuration information,
wherein the configuration information change step includes changing the configuration information of the configuration table when detecting that the second processing unit reception flag is turned on in accompaniment with execution of processing of the command relay control unit by the second processing unit, and
wherein the reference inhibition release step includes turning off the in-rewrite flag with completion of the change of the configuration information to force the second processing unit to terminate the processing of the command relay control unit.

15. The configuration information management program of claim 12, wherein the higher-priority control unit is a command relay control unit relaying commands between a system control unit managing the entire system and the second input/output control unit, the program further comprising:
a reference inhibition step of, when receiving the configuration information change instruction, acquiring a semaphore and then forcing the command relay control unit of the second processing unit to execute semaphore-acquisition processing to inhibit the second input/output processing unit from referring to the configuration table;
a configuration information change step of changing the configuration information of the configuration table with the reference to the configuration table being inhibited; and
a reference inhibition release step of releasing the semaphore with completion of the change of the configuration information to allow the command relay control unit of the second processing unit to acquire the semaphore, to thereafter terminate the semaphore-acquisition processing.

16. The configuration information management program of claim 12, wherein the higher-priority control unit is a command relay control unit relaying commands between a system control unit managing the entire system and the second input/output control unit, the program further comprising:
a reference inhibition step of, when receiving the configuration information change instruction, forcing the command relay control unit of the second processing unit to execute the relay queue readout processing to inhibit the second input/output processing unit from referring to the configuration table;
a configuration information change step of changing the configuration information of the configuration table with the reference to the configuration table being inhibited; and a reference inhibition release step of writing completion of the change of the configuration information into the relay queue to allow the command relay control unit of the second processing unit to terminate the relay queue readout processing.

17. A storage apparatus comprising:
a first processing unit including, as execution targets, a first input/output control unit which refers to configuration information to execute input/output processing of a volume and a configuration management unit which manages the configuration information; and
a second processing unit including, as an execution target, a second input/output control unit which refers to the configuration information to execute input/output processing of another volume,
wherein the storage apparatus is comprised of:
a shared memory which is allocated with a first configuration table storing the configuration information referred to by the first processing unit and a second configuration table storing the configuration information referred to by the second processing unit; and
a configuration information change control unit which changes the configuration information of the first configuration table when receiving a configuration information change instruction and then distributes the configuration information change instruction to the sub processor to change the configuration information of the second configuration table.

18. A storage apparatus comprising:
a first processing unit including, as execution targets, a first input/output control unit which refers to configuration information to execute input/output processing of a volume and a configuration management unit which manages the configuration information; and
a second processing unit including, as an execution target, a second input/output control unit which refers to the configuration information to execute input/output processing of another volume,
wherein the storage apparatus is comprised of:
a shared memory which is allocated with a first configuration table and a second configuration table in a mirror configuration individually storing the configuration information; and
a configuration information change control unit which sets a reference pointer to the second configuration table to change the configuration information of the first configuration table and subsequently sets a reference pointer to the first configuration table to change the configuration information of the second configuration table, when receiving a configuration information change instruction.

19. A storage apparatus comprising:
a first processing unit including, as execution targets, a first input/output control unit which refers to configuration information to execute input/output processing of a volume and a configuration management unit which manages the configuration information;
a second processing unit including, as an execution target, a second input/output control unit which refers to the configuration information to execute input/output processing of another volume; and
a shared memory which is allocated with a configuration table storing the configuration information,
wherein the storage apparatus is provided with a configuration information change control unit which instructs discontinuation processing for forcing the second processing unit to complete input/output requests already accepted and not to accept new inputs/outputs when receiving a configuration information change instruction, which then changes the configuration information of the configuration table and which instructs the second processing unit to resume the processing with completion of the change of the configuration information.

20. A storage apparatus comprising:
a first processing unit including, as execution targets, a first input/output control unit which refers to configuration information to execute input/output processing of a volume and a configuration management unit which manages the configuration information;
a second processing unit including, as an execution target, a second input/output control unit which refers to the configuration information to execute input/output processing of another volume; and
a shared memory which is allocated with a configuration table storing the configuration information,
wherein the storage apparatus is provided with a configuration information change control unit which inhibits the reference of the second input/output control unit by setting exclusive control information to the configuration table when receiving a configuration information change instruction, which then changes the configuration information of the configuration table and which releases the setting of the exclusive control information with completion of the change of the configuration information.
